(19) United States
(12) Patent Application Publication
(10) Pub. No.: US 2008/0248989 A1
(43) Pub. Date: Oct. 9, 2008

(54) Method For Producing Detergent Or Cleaning Products

(75) Inventors: Thomas Holderbaum, Hilden (DE); Arno Duffels, Dusseldorf (DE)

Correspondence Address: CONNOLLY BOVE LODGE & HUTZ LLP, PO BOX 2207, WILMINGTON, DE, 19899-2207, US

(73) Assignee: Henkel KGaA, Düsseldorf (DE)

(21) Appl. No.: 11/587,736

(22) PCT Filed: Apr. 20, 2005
(86) PCT No.: PCT/EP2005/004198

§ 371 Date: Dec. 6, 2006

(30) Foreign Application Priority Data
Apr. 28, 2004 (DE) 10 2004 020 720.8

(51) Int. Cl. C11D 17/04

(52) U.S. Cl. 510/445

(57) ABSTRACT

Products for washing, cleaning and/or detergent applications which comprise: (a) a shaped element comprising a first agent selected from washing and cleaning actives and mixtures thereof; and (b) at least one water-soluble or water-dispersible film material; wherein the film material is adherently joined to the shaped element by a heat-sealed seam, are described along with methods for their manufacture.

The present invention is in the field of washing or cleaning agents. The present invention relates in particular to a method for manufacturing washing or cleaning agents, in particular dispensing units for washing or cleaning agents.

Washing or cleaning agents are available today for consumers in numerous presentation forms. In addition to washing powders and washing granulates, this range also encompasses, for example, cleaning agent concentrates in the form of extruded or tableted compositions. These solid, concentrated or compressed presentation forms are characterized by a decreased volume per dispensed unit, and thus reduce costs for packaging and transport. The washing or cleaning agent tablets, in particular, additionally meet the consumer's desire for simple dispensing. The corresponding agents are comprehensively described in the existing art. In addition to the advantages mentioned, however, compacted washing or cleaning agents also have a number of disadvantages. Tableted presentation forms, in particular, are often characterized, because of their density, by delayed decomposition and thus delayed release of their ingredients. Numerous technical approaches to resolving this “conflict” between sufficient tablet hardness and short decomposition times have been disclosed in the patent literature; reference will be made at this juncture, by way of example, to the use of so-called tablet bursting agents. These decomposition accelerators are added to the tablets in addition to the substances having washing or cleaning activity, while they themselves generally exhibit no washing or cleaning action properties, and thus increase the complexity and costs of these agents. A further disadvantage of the tableting of active substance mixtures, in particular mixtures containing substances having washing or cleaning activity, is inactivation of the active substances contained therein by the compacting pressure that occurs during tableting. An inactivation of the active substances can occur by chemical reaction because of the enlarged contact surfaces of the ingredients as a consequence of tableting.

As an alternative to the particulate or compacted washing or cleaning agents described above, in recent years an increasing number of solid or liquid washing or cleaning agents have been described which comprise a water-soluble or water-dispersible package. These agents, like the tablets, are characterized by simplified dispensing, since they can be dispensed together with the surrounding package into the washing machine or automatic dishwasher, but on the other hand they make possible, at the same time, the packaging of liquid of powdered washing or cleaning agents that are characterized by better dissolution and faster effectiveness as compared with compactates.

For example, EP 1 314 654 A2 (Unilever) discloses a domed pouch having a receiving chamber that contains a liquid.

The subject matter of WO 01/83657 A2 (Procter & Gamble), on the other hand, is pouches that contain, in a receiving chamber, two particulate solids that are each present in fixed regions and do not mix with one another.

In addition to the packages that comprise only one receiving chamber, presentation forms have also been disclosed in the existing art which encompass more than one receiving chamber, or more than one packaging form.

The subject matter of European Patent Application EP 1 256 623 A1 (Procter & Gamble) is a kit made up of at least two pouches having different compositions and different appearances. The pouches are present separately from one another and not as a compact single product.

A method for manufacturing multi-chamber pouches by adhesively bonding two individual chambers is described by International Application WO 02/85736 A1 (Reckitt Benckiser).

The object of the present application was to make available a method for manufacturing washing or cleaning agents having a water-soluble or water-dispersible package, with which method the quantities of water-soluble or water-dispersible material used can be minimized, the water-soluble or water-dispersible package being intended to have stable sealed seams even without the use of usual adhesives or adhesion promoters. The resulting method products were furthermore intended to make possible the combined packaging of solid and liquid or flowable washing or cleaning agent compositions in mutually separated regions of a compact dispensing unit. The end product of the method was intended to be characterized by an attractive appearance.

These objects were achieved by a washing or cleaning agent in which a washing- or cleaning-agent shaped element, and the water-soluble or water-dispersible package material, are adherently joined to one another by a heat-sealed seam.

A first subject of the present Application is therefore a washing or cleaning agent encompassing at least one washing- or cleaning-agent shaped element as well as at least one water-soluble or water-dispersible film material, wherein the washing- or cleaning-agent shaped element and the film material are adherently joined to one another by a heat-sealed seam.

Unlike with conventional cleaning agents, in the case of the cleaning agents according to the present invention the sealed seam does not join two film materials, for example in order to seal a pouch in which a washing or cleaning agent is present, but instead joins the film material directly to the washing or cleaning agent. The adherent joining of film material and cleaning-agent shaped element preferably results in the formation of a cavity delimited by that film material and that shaped element, which cavity in turn can be filled, preferably with a further washing or cleaning agent. In an embodiment of this kind, it is preferred for the composition of the washing- or cleaning-agent shaped element to differ from the composition of the washing or cleaning agent filling the cavity.

The heat-sealed seam of the agents according to the present invention preferably takes the shape of a peripheral sealed seam, i.e. a continuous sealed seam. The thickness of the sealed seam is preferably between 0.1 and mm, preferably between 0.5 and 3 mm, and particularly preferably between 1 and 2 mm. The heat-sealed seam is formed by the fact that the film material and shaped element are brought into contact with one another, and then heated in a spatially defined region.

The heat sealing is accomplished preferably at a temperature above 40° C., particularly preferably above 60° C., very particularly preferably above 80° C., and in particular above 100° C. Preferably the film material and the adjacent region of the shaped element are heated for a maximum of 5 seconds, preferably for 0.1 to 4 seconds, particularly preferably for 0.2 to 3 seconds, and in particular for 0.4 to 2 seconds, to temperatures above 60° C., preferably above 80° C., particularly preferably between 100 and 120° C., and in particular to temperatures between 105 and 115° C.

Heat sealing of the washing- or cleaning-agent shaped element to the water-soluble or water-dispersible film material can also be accomplished by means of heated sealing tools, in addition to the action of hot air or the action of a laser beam. In the context of sealing with sealing tools (“sealing jaws”), the film material and shaped element are heated in the region of the subsequent sealed seam. The sealing tool can be guided to the surface of the shaped element, and can assist the sealing operation with additional pressure application. Preferred washing or cleaning agents are therefore characterized in that the shaped element has a breaking pressure above 1 bar, preferably above 2.5 bar, and in particular above 4 bar.

The breaking pressure is determined by placing the shaped element between two plane-parallel surfaces and moving the latter toward one another. The pressing force of the plates acts orthogonally to the plane of the heat-sealed seam. The breaking pressure is then determined, in consideration of the area of the plates used, from the force at which the shaped element collapses.

A first constituent of the agents according to the present invention is a washing- or cleaning-agent shaped element. Such shaped elements are obtainable, for example, by way of compacting methods such as tableting, by extrusion such as continuous extrusion, or with casting methods. Shaped elements that are manufactured by tableting or with casting methods are particularly preferably used in the context of the present Application. The shaped elements contain or are made up of substances or substance mixtures having washing or cleaning activity.

The manufacture of washing or cleaning agent tablets is performed, in the manner known to one skilled in the art, by compressing particulate starting substances. For manufacture of the tablets, the premix is compressed in a so-called mold between two dies, yielding a solid compressed body. This operation, which is referred to hereinafter for short as tableting, is subdivided into four portions: dispensing, compaction (elastic deformation), plastic deformation, and ejection. Tableting is preferably accomplished on so-called rotary presses.

In the context of tableting with rotary presses, it has proven advantageous to perform tableting with the smallest possible fluctuations in tablet weight. This also allows fluctuations in tablet hardness to be reduced. Small weight fluctuations can be achieved in the following fashion:
use of plastic inserts having small thickness tolerances
low rotor rotation speed
large filling shoes
coordination between filling shoe blade speed and rotor rotation speed
constant powder height in the filling shoe
decoupling of filling shoe and powder supply.

All anti-adhesion coatings known in the art are suitable for reducing die caking. Plastic coatings, plastic inserts, or plastic dies are particularly advantageous. Rotating dies have also proven advantageous; if possible, the upper and lower dies should be configured rotatably. A plastic insert can usually be dispensed with in the case of rotating dies. In this case the die surfaces should be electropolished.

Methods preferred in the context of the present invention are characterized in that compression is accomplished at press pressures from 0.01 to 50 kNcm⁻², preferably 0.1 to 40 kNcm⁻², and in particular 1 to 25 kNcm⁻².

Molded elements preferred according to the present invention are manufactured, for example, by pouring a preparation having washing or cleaning activity into a shaping tool and then unmolding the solidified molded element, forming a (recessed) shaped element. Tools that have cavities which can be filled with pourable substances preferably serve as a “shaping tool.”. Such tools can be embodied, for example, in the form of individual cavities, but also in the form of plates having multiple cavities. In industrial methods, the individual cavities or cavity plates are preferably mounted on horizontally circulating conveyor belts that make possible continuous or discontinuous transport of the cavities, for example along a series of different workstations (e.g. molding, cooling, filling, sealing, unmolding, etc.).

In the preferred method, the preparations having washing or cleaning activity are molded, and then solidify to form a dimensionally stable element. “Solidification” refers, in the context of the present invention, to any hardening mechanism that yields, from a shapable, preferably flowable mixture or a substance or mass of that kind, an element that is solid at room temperature, with no need for pressing or compacting forces. “Solidification” for purposes of the present invention is therefore, for example, the hardening of melts of substances that are solid at room temperature, by cooling. “Solidification operations” for purposes of the present Application are also the hardening of shapable masses by time-delayed water binding, by the evaporation of solvents, by chemical reaction, crystallization, etc., and the reactive curing of flowable powder mixtures to form stable hollow elements.

In general, all preparations having washing or cleaning activity that can be processed by molding techniques are suitable for processing. Preparations having washing or cleaning activity in the form of dispersions are, however, particularly preferred for use. In a particularly preferred embodiment of the present Application, the preparation having washing or cleaning activity that is molded into the receiving recess of the shaping tool is a dispersion of solid particles in a dispersing agent, dispersions containing, based on their total weight,

i) 10 to 85 wt % dispersing agent and

ii) 15 to 90 wt % dispersed substances,

being particularly preferred.

What is referred to as a dispersion in this Application is a system of multiple phases, of which one is continuous (dispersing agent) and at least one further is finely distributed (dispersed substances).

Suitable as dispersing agents in the context of the present invention are preferably the water-soluble or water-dispersible polymers, in particular the water-soluble or water-dispersible nonionic polymers. The dispersing agents can be both a single polymer and a mixture of different water-soluble or water-dispersible polymers. In a further preferred embodiment of the present invention, the dispersing agent or at least 50 wt % of the polymer mixture is made up of water-soluble or water-dispersible nonionic polymers from the group of the polyvinylpyrrolidones, vinylpyrrolidone/vinyl ester copolymers, cellulose ethers, polyvinyl alcohols, polyalkylene glycols, in particular polyethylene glycol and/or polypropylene glycol.

Particularly preferred for use are dispersions that contain as a dispersing agent at least one nonionic polymer, by preference a poly(alkylene) glycol, preferably a poly(ethylene) glycol and/or a poly(propylene) glycol, the weight proportion of the poly(ethylene) glycol in terms of the total weight of all dispersing agents being preferably between 10 and 90 wt %, particularly preferably between 30 and 80 wt %, and in particular between 50 and 70 wt %. Particularly preferred are dispersions in which more than 92 wt %, by preference more than 94 wt %, particularly preferably more than 96 wt %, very particularly preferably more than 98 wt %, and in particular 100 wt % of the dispersing agent is made up of a poly(alkylene) glycol, preferably poly(ethylene) glycol and/or poly(propylene) glycol, but in particular poly(ethylene) glycol. Dispersing agents that also contain poly(propylene) glycol in addition to poly(ethylene) glycol exhibit a ratio of the weight proportions of poly(ethylene) glycol to poly(propylene) glycol by preference between 40:1 and 1:2, preferably between 20:1 and 1:1, particularly preferably between 10:1 and 1.5:1, and in particular between 7:1 and 2:1.

Further preferred dispersing agents are the nonionic surfactants, which can be used either alone but particularly preferably in combination with a nonionic polymer. Detailed statements about the nonionic surfactants that can be used may be found below in the context of the description of substances having washing or cleaning activity.

Suitable as dispersed substances in the context of the present Application are all substances having washing or cleaning activity that are solid at room temperature, but in particular substances having washing or cleaning activity from the group of the builders and co-builders, the polymers having washing or cleaning activities, the bleaching agents, bleach activators, glass corrosion protection agents, silver protection agents, and/or enzymes. A more detailed description of these ingredients may be found in the text below.

Dispersions preferably used according to the present invention as washing- or cleaning-agent shaped elements are characterized in that they dissolve in water (40° C.) in less than 9 minutes, by preference less than 7 minutes, preferably in less than 6 minutes, particularly preferably in less than 5 minutes, and in particular in less than 4 minutes. To determine the solubility, 20 g of the dispersion is introduced into the interior of a dishwasher (Miele G 646 PLUS). The main washing phase of a standard washing cycle (45° C.) is started. The solubility is determined by measuring the conductivity, which is recorded via a conductivity sensor. The dissolution process is complete when a conductivity maximum is reached. In the conductivity diagram, this maximum corresponds to a plateau. The conductivity measurement begins with activation of the circulation pump in the main washing phase. The quantity of water used is 5 liters.

The shaped elements, manufactured for example by tableting or molding, can assume any geometrical form; concave, convex, biconcave, biconvex, cubic, tetragonal, orthorhombic, cylindrical, spherical, cylinder-segment-like, disk-shaped, tetrahedral, dodecahedral, octahedral, conical, pyramidal, ellipsoidal, pentagonally, heptagonally, and octagonally prismatic, and rhombohedral shapes are particularly preferred. Entirely irregular contours such as arrow shapes or animal shapes, trees, clouds, etc. can also be implemented. If the shaped elements according to the present invention have corners and edges, these are preferably rounded. As an additional visual differentiation, an embodiment having rounded corners and beveled (“chamfered”) edges is preferred.

The shaped elements can of course also be manufactured in multiple phases. For reasons of process economy, two-layer or three-layer shaped elements, in particular two-layer or three-layer tablets, have proven particularly successful here.

Those washing or cleaning agents according to the present invention in which the washing- or cleaning-agent shaped element is a single- or multiple-phase washing- or cleaning-agent tablet are particularly preferred in the context of the present invention.

In a particularly preferred embodiment, in step a) of the method according to the present invention tablets and/or compactates, for example roller compactates, and/or an extrudate and/or molded element, are used as the shaped element.

The washing- or cleaning-agent shaped elements according to the present invention can be entirely or partially encased by the water-soluble or water-dispersible film material. The film material, which is adherently joined to the shaped element by a heat-sealed seam, can therefore cover both the entire shaped element and individual regions of the shaped element. Washing- or cleaning-agent shaped elements according to the present invention that are covered with a film material over their entire surface are particularly preferred. Also preferred are shaped elements in which the film material covers only parts of the surface of the shaped element, for example individual lateral surfaces, in particular those lateral surfaces having a cavity.

In order to improve its shaped-element appearance and/or to influence its dissolution behavior, the shaped element can have a coating. The coating can cover both the entire shaped element and individual regions of the shaped element. Particularly preferably, shaped elements will have a coating over their entire surface. Also preferred are shaped elements in which the coating extends only onto individual surfaces of the shaped element, for example the shaped-element surfaces outside the cavity, or onto individual corners or edges of the shaped element.

All materials known to one skilled in the art for that purpose are suitable as coating materials. The water-soluble or non-water-soluble natural or synthetic organic polymers are preferably used as coating materials in the context of the present Application, water-soluble or water-dispersible organic polymers being particularly preferred. Additionally suitable for coating the shaped elements are the salts of organic or inorganic acids. Of the group of the organic acids, the salts of mono-, di-, tri-, tetra-, or polycarboxylic acids are particularly preferred in this context.

Polymers or polymer mixtures are particularly suitable as coating materials or as a constituent of the coating, for example as a binding agent in combination with salts, preferably inorganic salts, the polymer or at least 50 wt % of the polymer mixture being selected from
a) water-soluble nonionic polymers from the group of the
a1) polyvinylpyrrolidones,
a2) vinylpyrrolidone/vinyl ester copolymers,
a3) cellulose ethers
b) water-soluble amphoteric polymers from the group of the
b1) alkylacrylamide/acrylic acid copolymers
b2) alkylacrylamide/methacrylic acid copolymers
b3) alkylacrylamide/methylmethacrylic acid copolymers
b4) alkylacrylamide/acrylic acid/alkylaminoalkyl(meth)acrylic acid copolymers
b5) alkylacrylamide/methacrylic acid/alkylaminoalkyl(meth)acrylic acid copolymers
b6) alkylacrylamide/methylmethacrylic acid/alkylaminoalkyl(meth)acrylic acid copolymers
b7) alkylacrylamide/alkylmethacrylate/alkylaminoethylmethacrylate/alkylmethacrylate copolymers
b8) copolymers of
   b8i) unsaturated carboxylic acids
   b8ii) cationically derivatized unsaturated carboxylic acids
   b8iii) if applicable, further ionic or nonionogenic monomers
c) water-soluble zwitterionic polymers from the group of the
c1) acrylamidoalkyltrialkylammonium chloride/acrylic acid copolymers and their alkali and ammonium salts
c2) acrylamidoalkyltrialkylammonium chloride/methacrylic acid copolymers and their alkali and ammonium salts
c3) methacroylethyl betaine/methacrylate copolymers
d) water-soluble anionic polymers from the group of the
d1) vinyl acetate/crotonic acid copolymers
d2) vinylpyrrolidone/vinyl acrylate copolymers
d3) acrylic acid/ethyl acrylate/N-tert.butylacrylamide terpolymers
d4) graft polymers of vinyl esters, esters of acrylic acid or methacrylic acid alone or mixed, copolymerized with crotonic acid, acrylic acid, or methacrylic acid with olyalkylene oxides and/or polykalkylene glycols
d5) grafted and crosslinked copolymers from the copolymerization of
   d5i) at least one monomer of the nonionic type,
   d5ii) at least one monomer of the ionic type,
   d5iii) polyethylene glycol, and
   d5iv) a crosslinker
d6) copolymers obtained by copolymerization of at least one monomer of each of the following three groups:
   d6i) esters of unsaturated alcohols and short-chain saturated carboxylic acids and/or esters of short-chain saturated alcohols and unsaturated carboxylic acids,
   d6ii) unsaturated carboxylic acids,
   d6iii) esters of long-chain carboxylic acids and unsaturated alcohols and/or esters of the carboxylic acids of group d6ii) with saturated or unsaturated, straight-chain or branched C₈₋₁₈ alcohols
d7) terpolymers of crotonic acid, vinyl acetate, and an allyl or methallyl ester
d8) tetra- and pentapolymers of
   d8i) crotonic acid or allyloxyacetic acid
   d8ii) vinyl acetate or vinyl propionate
   d8iii) branched allyl or methallyl esters
   d8iv) vinyl ethers, vinyl esters, or straight-chain allyl or methallyl esters
d9) crotonic acid copolymers with one or more monomers from the group of ethylene, vinylbenzene, vinylmethyl ether, acrylamide, and their water-soluble salts
d10) terpolymers of vinyl acetate, crotonic acid, and vinyl esters of a saturated monocarboxylic acid branched in the α-position
e) water-soluble cationic polymers from the group of the
e1) quaternized cellulose derivatives
e2) polysiloxanes having quaternized groups
e3) cationic guar derivatives
e4) polymeric dimethyldiallylammonium salts and their copolymers with esters and amides of acrylic acid and methacrylic acid
e5) copolymers of vinylpyrrolidone with quaternized derivatives of dialkylamino acrylate and methacrylate
e6) vinylpyrrolidone-methoimidazolinium chloride copolymers
e7) quaternized polyvinyl alcohol

e8) polymers listed under the INCI names Polyquaternium 2, Polyquaternium 17, Polyquaternium 18, and Polyquaternium 27.

Water-soluble polymers for purposes of the invention are those polymers that are soluble in water at a proportion of more than 2.5 wt %.

The shaped elements are preferably coated with a polymer or polymer mixture, the polymer (and accordingly the entirely coating) or at least 50 wt % of the polymer mixture (and thus at least 50% of the coating) being selected from specific polymers. The entire coating, or at least 50% of its weight, is made up of water-soluble polymers from the group of the nonionic, amphoteric, zwitterionic, anionic, and/or cationic polymers. In a further preferred embodiment, the coating of the shaped element is made up of a further inorganic salt that contains one of the aforesaid polymers as a binding agent. Preferred polymers from these groups were listed above and will be described in further detail below.

Water-soluble polymers that are preferred according to the present invention are nonionic. Suitable nonionic polymers are, for example:
Polyvinylpyrrolidones such as those marketed, for example, under the name Luviskol® (BASF). Polyvinylpyrrolidones are preferred nonionic polymers in the context of the invention. Polyvinylpyrrolidones [poly(1-vinyl-2-pyrrolidinones)], abbreviated PVP, are polymers of the general formula:

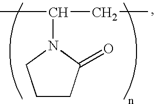

that are produced by radical polymerization of 1-vinylpyrrolidone in accordance with solution or suspension polymerization methods using radical formers (peroxides, azo compounds) as initiators. Ionic polymerization of the monomer yields only products having low molar weights. Commercially usual polyvinylpyrrolidones have molar weights in the range from approx. 2500 to 750,000 g/mol; they are characterized by indication of the K values, and possess glass transition temperatures of 130-175° C. (depending on K value). They are presented as white, hygroscopic powders or as aqueous solutions. Polyvinylpyrrolidones are readily soluble in water and a plurality of organic solvents (alcohols, ketones, glacial acetic acid, chlorinated hydrocarbons, phenols, and others).
Vinylpyrrolidone/vinyl ester copolymers, such as those marketed under the trademark Luviskol® (BASF). Luviskol® VA 64 and Luviskol® VA 73, which are each vinylpyrrolidone/vinyl ester copolymers, are particularly preferred nonionic polymers. The vinyl ester polymers are polymers, accessible from vinyl esters, having the grouping of formula

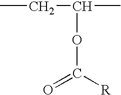

as a characteristic basic module of the macromolecule. Of these, the vinyl acetate polymers (R═CH₃) with polyvinyl acetates are the representatives having by far the greatest industrial importance.
Polymerization of the vinyl esters is accomplished radically in accordance with various methods (solution polymerization, suspension polymerization, emulsion polymerization, substance polymerization).
Cellulose ethers, such as hydroxypropyl cellulose, hydroxyethyl cellulose, and methylhydroxypropyl cellulose, such as those marketed, for example, under the trademarks Culminal® and Benecel® (AQUALON).
Cellulose ethers can be described by the following general formula:

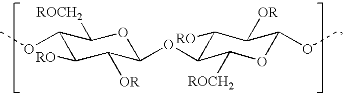

in which R denotes H or an alkyl, alkenyl, alkinyl, aryl, or alkylaryl radical. In preferred products, at least one R in the formula denotes —CH₂CH₂CH₂—OH or —CH₂CH₂—OH. Cellulose ethers are produced industrially by the etherification of alkaline celluloses (e.g. with ethylene oxide). Cellulose ethers are characterized by way of the average degree of substitution DS or the molar degree of substitution MS, which indicate respectively how many hydroxy groups of an anhydroglucose unit of the cellulose have reacted with the etherification reagent, and how many moles of the etherification reagent have attached, on average, to an anhydroglucose unit. Hydroxyethyl celluloses are water-soluble above a DS of approximately 0.6 or an MS of approximately 1. Commercially usual hydroxyethyl and hydroxypropyl celluloses have degrees of substitution in the range of 0.85-1.32 (DS) or 1.5-3 (MS). Hydroxyethyl and propyl celluloses are marketed as yellowish-white, odorless and tasteless powders, in a wide variety of degrees of polymerization. Hydroxyethyl and propyl celluloses are soluble in cold and hot water and in some (hydrous) organic solvents, but insoluble in most (anhydrous) organic solvents; their aqueous solutions are relatively insensitive to changes in pH or to electrolyte addition.

Further polymers preferred according to the present invention are water-soluble amphopolymers. The general term “amphopolymer” encompasses amphoteric polymers, i.e. polymers that contain in the molecule both free amino groups and —COOH— or SO₃H groups and are capable of forming internal salts; zwitterionic polymers, which contain quaternary ammonium groups and —COO⁻— or —SO₃⁻ groups in the molecule; and those polymers that contain —COOH— or SO₃H groups and quaternary ammonium groups. One example of an amphopolymer usable according to the present invention is the acrylic resin obtainable under the name Amphomer®, which represents a copolymer of tert.-butylaminoethyl methacrylate, N-(1,1,3,3-tetramethylbutyl)acrylamide, and two or more monomers from the group of acrylic acid, methacrylic acid, and their simple esters. Similarly preferred amphopolymers are made up of unsaturated carboxylic acids (e.g. acrylic and methacrylic acid), cationically derivatized unsaturated carboxylic acids (e.g. acrylamidopropyltrimethylammonium chloride), and optionally further ionic or nonionogenic monomers, such as those inferable from German Unexamined Application 39 29 973 and the existing art cited therein. Terpolymers of acrylic acid, methyl acrylate, and methacrylamidopropyltrimonium chloride, such as those available commercially under the name Merquat® 2001 N, are amphopolymers that are particularly preferred according to the present invention. Further suitable amphoteric polymers are, for example, the octylacrylamide/methyl methacrylate/tert.-butylaminoethyl methacrylate/2-hydroxypropyl methacrylate copolymers available under the names Amphomer® and Amphomer® LV-71 (DELFT NATIONAL).

Suitable zwitterionic polymers are, for example, acrylamidopropyltrimethylammonium chloride/acrylic acid or methacrylic acid copolymers and their alkali and ammonium salts. Further suitable zwitterionic polymers are methacroylethylbetaine/methacrylate copolymers that are obtainable commercially under the name Amersette® (AMERCHOL).

Anionic polymers suitable according to the present invention are, among others:
Vinyl acetate/crotonic acid copolymers such as those marketed, for example, under the names Resyn® (NATIONAL STARCH), Luviset® (BASF) and Gafset® (GAF).
These polymers have monomer units of the general formula

[—CH(CH₃)—CH(COOH)—]ₙ.
Vinylpyrrolidone/vinyl acrylate copolymers obtainable, for example, under the trade name Luviflex® (BASF). A preferred polymer is the vinylpyrrolidone/acrylate terpolymers obtainable under the name Luviflex® VBM-35 (BASF).
Acrylic acid/ethyl acrylate/N-tert.butylacrylamide terpolymers such as those marketed, for example, under the name Ultrahold® strong (BASF).
Graft polymers of vinyl esters, esters of acrylic acid or methacrylic acid alone or mixed, copolymerized with crotonic acid, acrylic acid, or methacrylic acid with polyalkylene oxides and/or polykalkylene glycols.
Grafted polymers of this kind, of vinyl esters, esters or acrylic acid or methacrylic acid, alone or mixed with other copolymerizable compounds on polyalkylene glycols, are obtained by hot polymerization in a homogeneous phase by the fact that the polyalkylene glycols are mixed into the monomers of the vinyl esters or esters of acrylic acid or methacrylic acid in the presence of radical formers.
Vinyl esters that have proven suitable are, for example, vinyl acetate, vinyl propionate, vinyl butyrate, vinyl benzoate; and suitable esters of acrylic acid or methacrylic acid are those that are obtainable with low-molecular-weight aliphatic alcohols, i.e. in particular ethanol, propanol, isopropanol, 1-butanol, 2-butanol, 2-methyl-1-propanol, 2-methyl-2-propanol, 1-pentanol, 2-pentanol, 3-pentanol, 2,2-dimethyl-1-propanol, 3-methyl-1-butanol; 3-methyl-2-butanol, 2-methyl-2-butanol, 2-methyl-1-butanol, 1-hexanol.
Suitable polyalkylene glycols are, in particular, polyethylene glycols and polypropylene glycols. Polymers of ethylene glycol that conform to the general formula

H—(O—CH₂—CH₂)ₙ—OH
where n can assume values between 1 (ethylene glycol) and several thousand. Various nomenclatures exist for polyethylene glycols, and can result in confusion. The common technical practice is to indicate the average relative molecular weight following the term “PEG”, so that “PEG 200” characterizes a polyethylene glycol having a relative molar weight of approximately 190 to approximately 210. For cosmetic ingredients a different nomenclature is used, in which the abbreviation PEG has a hyphen added to it, and the hyphen is followed directly by a number corresponding to the number n in the above formula V. According to this nomenclature (so-called INCI nomenclature, CTFA International Cosmetic Ingredient Dictionary and Handbook, 5th Edition, The Cosmetic, Toiletry and Fragrance Association, Washington, 1997), for example, PEG-4, PEG-6, PEG-8, PEG-9, PEG-10, PEG-12, PEG-14, and PEG-16 can be used. Polyethylene glycols are available commercially, for example, under the trade names Carbowax® PEG 200 (Union Carbide), Emkapol® 200 (ICI Americas), Lipoxol® 200 MED (HÜLS America), Polyglycol® E-200 (Dow Chemical), Alkapol® PEG 300 (Rhone-Poulenc), Lutrol® E300 (BASF), and the corresponding trade names with higher numbers.
Polypropylene glycols (abbreviated PPG) are polymers of propylene glycol that conform to the general formula

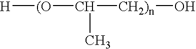

where n can assume values between 1 (propylene glycol) and several thousand. Of particular industrial significance here are di-, tri-, and tetrapropylene glycol, i.e. the representatives having n=2, 3, and 4 in the above formula.
The vinyl acetate copolymers grafted onto polyethylene glycols, and the polymers of vinyl acetate and crotonic acid grafted onto polyethylene glycols, can be used in particular.
grafted and crosslinked copolymers resulting from the copolymerization of
i) at least one monomer of the nonionic type,
ii) at least one monomer of the ionic type,
iii) polyethylene glycol, and
iv) a crosslinker.

The polyethylene glycol used has a molecular weight between 200 and several million, preferably between 300 and 30,000. The nonionic monomers can be of very different types, and among them the following are preferred: vinyl acetate, vinyl stearate, vinyl laurate, vinyl propionate, allyl stearate, allyl laurate, diethyl maleate, allyl acetate, methyl methacrylate, cetylvinyl ether, stearylvinyl ether, and 1-hexene.
The ionic monomers can similarly be of very different types; among them crotonic acid, allyloxyacetic acid, vinylacetic acid, maleic acid, acrylic acid, and methacrylic acid can particularly preferably be contained in the graft polymers.
The crosslinkers used are preferably ethylene glycol dimethacrylate, diallyl phthalate, ortho-, meta- and paradivinylbenzene, tetraallyloxyethane, and polyallylsucroses having 2 to 5 alkyl groups per molecule of saccharin.
The above-described grafted and crosslinked copolymers are preferably constituted from:
i) 5 to 85 wt % of at least one monomer of the nonionic type,
ii) 3 to 80 wt % of at least one monomer of the ionic type,
iii) 2 to 50 wt %, preferably 5 to 30 wt %, polyethylene glycol, and
iv) 0.1 to 8 wt % of a crosslinker, the percentage of the crosslinker being constituted by the ratio of the total weights of i), ii), and iii).
Copolymers obtained by copolymerization of at least one monomer of each of the three following groups:
i) esters of unsaturated alcohols and short-chain saturated carboxylic acids and/or esters of short-chain saturated alcohols and unsaturated carboxylic acids,
ii) unsaturated carboxylic acids,
iii) esters of long-chain carboxylic acids and unsaturated alcohols and/or esters of the carboxylic acids of group ii) with saturated or unsaturated, straight-chain or branched C₈₋₁₈ alcohol.
“Short-chain” carboxylic acids and alcohols are to be understood as those having 1 to 8 carbon atoms, in which context the carbon chains of these compounds can optionally be interrupted by double-bond hetero groups such as —O—, —NH—, —S—.
Terpolymers of crotonic acid, vinyl acetate, and an allyl or methallyl ester. These terpolymers contain, in addition to further monomer units, monomer units of one or more allyl or methyallyl esters of the formula

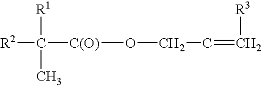

in which R³ denotes —H or —CH₃, R² denotes —CH₃ or —CH(CH₃)₂, and R¹ denotes —CH₃ or a saturated straight-chain or branched C₁₋₆ alkyl radical, and the sum of the carbon atoms in radicals R¹ and R² is preferably 7, 6, 5, 4, 3, or 2.
The aforesaid terpolymers preferably result from the copolymerization of 7 to 12 wt % crotonic acid, 65 to 86 wt %, preferably 71 to 83 wt %, vinyl acetate, and 8 to 20 wt %, preferably 10 to 17 wt %, allyl or methallyl esters of the above formula.
Tetra- and pentapolymers of
i) crotonic acid or allyloxyacetic acid
ii) vinyl acetate or vinyl propionate
iii) branched allyl or methallyl esters
iv) vinyl ethers, vinyl esters, or straight-chain allyl or methallyl esters.
Crotonic acid copolymers with one or more monomers from the group of ethylene, vinyl benzene, vinylmethyl ether, acrylamide, and their water-soluble salts.
Terpolymers of vinyl acetate, crotonic acid, and vinyl esters a of saturated aliphatic monocarboxylic acid branched in the □ position.

Further polymers that are preferably usable as a constituent of the coating are cationic polymers. Among the cationic polymers, the permanently cationic polymers are preferred. According to the present invention, those polymers that possess a cationic group regardless of the pH of the agent (i.e. of both the coating and the shaped element) are referred to as “permanently cationic.” These are, as a rule, polymers that contain a quaternary nitrogen atom, for example in the form of an ammonium group.

Preferred cationic polymers are, for example,
quaternized cellulose derivatives such as those obtainable commercially under the designations Celquat® and Polymer JR®. The compounds Celquat® H 100, Celquat® L 200, and Polymer JR® 400 are preferred quaternized cellulose derivatives;
polysiloxanes having quaternary groups, such as, for example, the commercially obtainable products Q2-7224 (manufacturer: Dow Corning; a stabilized trimethylsilylamodimethicone), Dow Corning® 929 Emulsion (containing a hydroxylamino-modified silicone that is also referred to as amodimethicone), SM-2059 (manufacturer: General Electric), SLM-55067 (manufacturer: Wacker), and Abil®-Quat 3270 and 3272 (manufacturer: Th. Goldschmid; diquaternary polydimethylsiloxanes, Quaternium-80);
cationic guar derivatives such as, in particular, the products marketed under the trade names Cosmedia® Guar and Jaguar®;
polymeric dimethyldiallylammonium salts and their copolymers with esters and amides of acrylic acid and methacrylic acid. The products available commercially under the designations Merquat® 100 (poly(dimethyldiallylammonium chloride)) and Merquat® 550 (dimethyldiallylammonium chloride/acrylamide copolymer) are examples of such cationic polymers.
copolymers of vinylpyrrolidone with quaternized derivatives of dialkylaminoalkyl acrylate and methacrylate, such as, for example, vinylpyrrolidone/dimethylaminoethyl methacrylate copolymers quaternized with diethyl sulfate. Such compounds are obtainable commercially under the designations Gafquat® 734 and Gafquat® 755;
vinylpyrrolidone/methoimidazolium chloride copolymers, such as those offered under the designation Luviquat®;
quaternized poly(vinylalcohol);
   and the polymers, known under the names
Polyquaternium 2,
Polyquaternium 17,
Polyquaternium 18, and
Polyquaternium 27,
   having quaternary nitrogen atoms in the main polymer chain. The aforesaid polymers are designated in accordance with so-called INCI nomenclature, more detailed information being available in the CTFA International Cosmetic Ingredient Dictionary and Handbook, 5^{th} Edition, The Cosmetic, Toiletry and Fragrance Association, Washington, 1997, to which reference is explicitly made here.

Cationic polymers preferred according to the present invention are quaternized cellulose derivatives as well as polymeric dimethyldiallylammonium salts and their copolymers. Cationic cellulose derivatives, in particular the commercial product Polymer® JR 400, are very particularly preferred cationic polymers.

A coating material for shaped elements that is particularly preferred in the context of the present Application is polyvinyl alcohol (PVA). With regard to the degree of hydrolysis and molecular weight of the polyvinyl alcohols preferably used for the coating, the statements made below in the description with respect to the preferred container materials apply, and the reader is referred thereto in order to avoid repetitions.

A second group of coating materials preferred according to the present invention is the water-insoluble coating materials, in particular the coating materials from the group of the fats, triglycerides, and waxes.

“Fat(s) or triglyceride(s)” is the designation for compounds of glycerol in which the three hydroxy groups of glycerol are esterified with carboxylic acids. The naturally occurring fats are triglycerides that, as a rule, contain different fatty acids in the same glycerol molecule. Synthetic triglycerides in which only one fatty acid is bound (e.g. tripalmitin, triolein, or tristearin) are, however, also accessible by saponification of the fats and subsequent esterification or reaction with acyl chlorides. Natural and/or synthetic fats and/or mixtures of the two are preferred as a coating material in the context of the present invention.

In the present Application, aliphatically saturated or unsaturated carboxylic acids having a branched or unbranched carbon chain are referred to as “fatty acids.” A number of production methods exist for producing fatty acids. Whereas the lower fatty acids are usually based on oxidative methods proceeding from alcohols and/or aldehydes as well as aliphatic or acyclic hydrocarbons, the higher homologs are still for the most part, even today, most easily accessible via the saponification of natural fats. As a result of progress in transgenic plants, almost unlimited possibilities now exist for varying the fatty acid spectrum in the stored fats of oil plants. Preferred fatty acids exhibit, in the context of the present invention, a melting point that permits processing of these fats as a material or constituent of a molded element. Fatty acids that have a melting point above 25° C. have proven particularly advantageous. Preferred matrix materials and/or matrix constituents are therefore decanoic acid and/or undecanoic acid and/or lauric acid and/or tridecanoic acid and/or myristic acid and/or pentadecanoic acid and/or palmitic acid and/or margaric acid and/or stearic acid and/or nonadecanoic acid and/or arachidic acid and/or erucic acid and/or elaeostearic acid. Fatty acids having a melting point below 25° C. can also, however, be a constituent of the coating.

“Fatty alcohol” is a collective term for the linear, saturated or unsaturated, primary alcohols, having 6 to 22 carbon atoms, obtainable by the reduction of triglycerides, fatty acids, or fatty acid esters. The fatty alcohols can be saturated or unsaturated, depending on the production method. Myristyl alcohol and/or 1-pentadecanol and/or cetyl alcohol and/or 1-heptadecanol and/or stearyl alcohol and/or erucyl alcohol and/or 1-nonadecanol and/or arachidyl alcohol and/or 1-heneicosanol and/or behenyl alcohol and/or erucyl alcohol and/or brassidyl alcohol are preferred constituents of the coatings.

It has likewise proven to be advantageous if the coating materials contain waxes. Preferred waxes have a melting range that is between approximately 45° C. and approximately 75° C. In the present case, this means that the melting range occurs within the indicated temperature interval, and does not refer to the width of the melting range. Waxes having a melting range of this kind are one the one hand geometrically stable at room temperature, but melt at the temperatures (300 to 90° C.) typical of automatic dishwashing, and are therefore readily water-dispersible at those temperatures.

“Waxes” are understood as a number of natural or artificially obtained substances that as a rule melt above 40° C. without decomposition, and just above the melting point are already relatively low in viscosity and not stringy. They exhibit a highly temperature-dependent consistency and solubility.

Waxes are divided into three groups depending on their derivation: natural waxes, chemically modified waxes, and synthetic waxes.

The natural waxes include, for example, vegetable waxes such as candelilla wax, carnauba wax, Japan wax, esparto grass wax, cork wax, guaruma wax, rice seed oil wax, sugar cane wax, ouricury wax, or montan wax; animal waxes such as beeswax, shellac wax, spermaceti, lanolin (wool wax), or uropygial grease; mineral waxes such as ceresin or ozocerite (earth wax); or petrochemical waxes such as petrolatum, paraffin waxes, or microcrystalline waxes.

The chemically modified waxes include, for example, hard waxes such as montan ester waxes, sassol waxes, or hydrogenated jojoba waxes.

Synthetic waxes are usually understood to be polyalkylene waxes or polyalkylene glycol waxes. Also usable as meltable or softenable substances for the masses that harden by cooling are compounds from other substance classes that meet the stated requirements in terms of softening point. For example, higher esters of phthalic acid, in particular dicyclohexyl phthalate, which is commercially available under the name Unimoll® 66 (Bayer AG), have proven to be suitable synthetic compounds. Also suitable are synthetically produced waxes from lower carboxylic acids and fatty alcohols, for example dimyristyl tartrate, which is obtainable under the name Cosmacol® ETLP (Condea). Also usable, conversely, are synthetic or partially synthetic esters from lower alcohols with fatty acids from natural sources. This substance class contains, for example, Tegin® 90 (Goldschmidt), a glycerol monostearate-palmitate. Shellac, for example Schellack-KPS-Dreiring-SP (Kalkhoff GmbH), is also usable according to the present invention as a coating material.

Also considered among the waxes in the context of the present invention are, for example, the so-called waxy alcohols. Waxy alcohols are higher-molecular-weight, water-insoluble fatty alcohols usually having approximately 22 to 40 carbon atoms. The waxy alcohols occur, for example in the form of wax esters of higher-molecular-weight fatty acids (waxy acids), as a principal constituent of many natural waxes. Examples of waxy alcohols are lignoceryl alcohol (1-tetracosanol), cetyl alcohol, myristyl alcohol, or melissyl alcohol. The encasing of the solid particles encased according to the present invention can, if applicable, also contain wool wax alcohols, which are to be understood as the triterpenoid and steroid alcohols, for example lanolin, which is obtainable e.g. under the commercial designation Argowax® (Pamentier & Co.).

In a further preferred embodiment, the shaped elements contain paraffin wax in a predominant proportion as a coating material. In other words, at least 50 wt % of the coating material, preferably more, is made up of paraffin wax. Paraffin wax contents (based on the total weight of the coating materials) of approximately 60 wt %, approximately 70 wt %, or approximately 80 wt % are particularly suitable, even higher proportions, e.g. of more than 90%, being particularly preferred. In a particular embodiment of the invention, the entire volume of the coating material is made up of paraffin wax.

Paraffin waxes are made up principally of alkanes, as well as small proportions of iso- and cycloalkanes. The paraffin to be used according to the present invention preferably has substantially no constituents having a melting point of more than 70° C., in particularly preferred fashion more than 60° C.

Preferred solid particles comprise, as a coating material or as a constituent of the coating, at least one paraffin wax having a melting range of 40° C. to 60° C.

Further advantageous constituents of the coating of shaped elements are waxy alcohols, i.e. fatty alcohols having approximately 24 to 36 carbon atoms that, in the form of wax esters of higher-molecular-weight fatty acids (waxy acids), are a principal constituent of many natural waxes. Examples of waxy alcohols that may be mentioned here are lignoceryl alcohol, ceryl alcohol, myricyl alcohol, or melissyl alcohol.

It is preferred in the context of the present invention that the quantity of the coating substance(s), based on the total weight of the coated shaped element, be between 0.5 and 15 wt %, preferably between 1 and 12 wt %, and in particular between 2 and 8 wt %.

Preferred methods according to the present invention are accordingly characterized in that the shaped element comprises a coating.

The washing- or cleaning-agent shaped elements can comprise a cavity. The term “cavity” characterizes, in the context of the present invention, both recesses and apertures or holes, passing through the shaped element, that interconnect two sides of the shaped element, preferably opposite sides of the shaped element, for example the bottom and top surfaces of the shaped element.

The shape of the cavity, which preferably is a recess, can be selected unrestrictedly, tablets in which at least one recess can assume a concave, convex, cubic, tetragonal, orthorhombic, cylindrical, spherical, cylinder-segment-like, disk-shaped, tetrahedral, dodecahedral, octahedral, conical, pyramidal, ellipsoidal, pentagonally, heptagonally, and octagonally prismatic, and rhombohedral shape being preferred. Entirely irregular contours such as arrow shapes or animal shapes, trees, clouds, etc. can also be implemented. As in the case of the basic shaped elements, recesses having rounded corners and edges, or having rounded corners and chamfered edges, are preferred. The bottom surface of the recess can be plane or inclined.

The recess opening surface can be planar. In a recess opening of this kind, all the delimiting points of the recess opening lie in one plane. In a preferred embodiment, the surface forming the recess opening is not planar. An embodiment of this kind can be implemented, for example, by way of a shaped element having an uneven surface. Alternatively, a shaped element can be made available whose recess opening extends over at least two delimiting surfaces of a shaped element.

In a further preferred embodiment, the cavity is an aperture that interconnects two opposite sides of the shaped element. If a tablet is used as a shaped element, the shaped element having an aperture of this kind then corresponds to a so-called ring tablet. It is particularly preferred to use those shaped elements having an aperture in which the opening surfaces of the aperture on the opposite sides of the shaped element differ, based on the larger of the two opening surfaces, by less than 80%, by preference less than 60%, preferably less than 40%, particularly preferably less than 20%, and in particular less than 10%. The cross section of the aperture can be angular or round. Cross sections having one, two, three, four, five, six, or more corners can be realized, but those shaped elements that comprise an aperture without corners, preferably an aperture having a round or oval cross section, are particularly preferred in the context of the present Application. The term “cross section” refers to a surface that is perpendicular to a straight connecting line between the center points of the two oppositely located opening surfaces of the shaped element.

The shaped element can of course comprise more than one cavity. Shaped elements having two, three, four, five, six, seven, eight, nine, ten, eleven, twelve, or more cavities are particularly preferred in the context of the present Application. If the shaped element comprises more than one cavity, these cavities can be both the above-described recesses and the above-described apertures. Shaped elements that comprise more than one cavity, at least one of the cavities being a recess and at least further one of the cavities being an aperture, are particularly preferred in the context of the present Application.

The volume of the cavity is by preference between 2 and 20 ml, preferably between 2 and 15 ml, particularly preferably between 2 and 10 ml, and in particular between 2 and 7 ml.

In the context of the present Application, washing- or cleaning-agent shaped elements that comprise a cavity are particularly preferred. Very particularly preferred are those washing or cleaning agents according to the present invention in which the shaped element comprises a cavity that is at least in part closed off by the film material that is adherently joined to the shaped element by a heat-sealed seam.

In a particularly preferred embodiment of the present invention, the cavity of the washing- or cleaning-agent shaped element is filled. Preferably, flowable preparations having washing and cleaning activity, preferably liquid(s), in particular melts and/or gel(s) and/or powder(s) and/or granulate(s) and/or extrudate(s) and/or compactates, are introduced into the cavity of the washing- or cleaning-agent shaped element.

In the present Application, the term “liquid” refers to substances or substance mixtures, as well as solutions or suspensions, that are present in the liquid aggregate state.

“Powder” is a general designation for a divided form of solid substances and/or substance mixtures that is obtained by comminution, i.e. crushing or pounding in a mortar, milling in mills, or as a consequence of nebulization or freeze-drying. A particularly fine division is often called atomization or micronization; the corresponding powders are referred to as micro-powders.

A general subdivision of powders in accordance with particle size, into coarse, fine, and ultrafine powders, is usual; a more precise classification of powdered bulk materials is accomplished by way of their bulk density and by sieve analysis. Powders preferred in the context of the present Application, however, exhibit lower particle sizes below 5000 μm, by preference less than 3000 μm, preferably less than 1000 μm, very particularly preferably between 50 and 1000 μm, and in particular between 100 and 800 μm.

Powders can be compressed and agglomerated by extrusion, pressing, rolling, briquetting, pelleting, and related methods. Any method known in the existing art for the agglomeration of particulate mixtures is suitable in principle for manufacturing the solids contained in the agents according to the present invention. Preferred in the context of the present invention as agglomerates used as solid(s) are, in addition to the granulates, the compactates and extrudates.

The term “granulates” refers to accumulations of granulate particles. A granulate particle (granule) is an asymmetrical aggregate of powder particles. Granulation methods are widely described in the existing art. Granulates can be produced by wet granulation, by dry granulation or compacting, and by melt solidification granulation.

The most common granulation technology is wet granulation, since this technology is subject to the fewest limitations and most reliably yields granulates having favorable properties. Wet granulation is accomplished by moistening the powder mixtures with solvents and/or solvent mixtures and/or solutions of binding agents and/or solutions of adhesives, and is preferably carried out in mixers, fluidized beds, or spray towers, in which context said mixers can be equipped, for example, with agitation and kneading tools. Also usable for granulation, however, are combinations of fluidized bed(s) and mixer(s), or combinations of different mixers. Granulation is accomplished, depending on the starting material and the desired product properties, with the application of small to large shear forces.

If granulation is accomplished in a spray tower, the starting substances used can be, for example, melts (melt solidification) or (preferably aqueous) slurries (spray drying) of solid substances, which are sprayed in at the top of a tower at a defined droplet size, solidify or dry in free fall, and accumulate as a granulate at the base of the tower. Melt solidification is generally suitable in particular for shaping low-melting-point substances that are stable in the region of the melting temperature (e.g. urea, ammonium nitrate, and various formulations such as enzyme concentrates, pharmaceuticals, etc.); the corresponding granulates are also referred to as prills. Spray drying is used in particular for the production of washing agents or washing-agent constituents.

Further agglomeration technologies described in the existing art are extruder or orifice-roller granulating systems, in which powder mixtures with granulating liquid optionally added are plastically deformed upon compression through orifice plates (extrusion) or on orifice rollers. The products of extruder granulation are also referred to as extrudates.

Particularly suitable as ingredients of the preparations having washing or cleaning activity that are introduced into the cavity of the washing- or cleaning-agent shaped element are enzymes, bleaching agents, bleach activators, bleach catalysts, silver protection agents, or glass corrosion inhibitors. Particularly advantageously, bleaching agents, in particular peroxygen compounds such as percarbonates or perborates, bleach activators, or silver protection agents are introduced. These ingredients are preferably introduced into the cavity, as a constituent of solid preparations having washing or cleaning activity, between steps a) and b). These ingredients are described in more detail in the text below. At this juncture, to avoid repetition, the reader is referred to the statements therein.

A further preferred subject of the present Application is therefore a washing or cleaning agent encompassing at least one washing- or cleaning-agent shaped element as well as at least one water-soluble or water-dispersible film material, wherein the washing- or cleaning-agent shaped element comprises a cavity in the form of a recess that is filled with a substance having washing or cleaning activity and is sealed with a film material, the film material being joined adherently, by way of a heat-sealed seam, to the washing- or cleaning-agent shaped element.

The shaped element can of course also comprise an aperture instead of a recess, shaped elements in the form of a ring tablet being used with particular advantage. Such shaped elements can be manufactured not only by tableting, as described above, but for example also by molding methods or by continuous extrusion. The subject matter of the present Application is therefore furthermore a washing or cleaning agent encompassing at least one washing- or cleaning-agent shaped element in the form of a ring tablet as well as at least one water-soluble or water-dispersible film material, wherein the cavity of the washing- or cleaning-agent shaped element is filled with a substance having washing or cleaning activity, the film material being joined adherently, by way of a heat-sealed seam, to the washing- or cleaning-agent shaped element, and preferably sealing at least one, particularly preferably both, openings of the cavity of the shaped element.

In the embodiments described above of agents according to the present invention, a washing- or cleaning-agent shaped element was adherently joined, by means of a heat-sealed seam, to a water-soluble or water-dispersible film material, the water-soluble or water-dispersible film material having been used in the form of a commercially usual film. In a further preferred embodiment, the water-soluble or water-dispersible film material is shaped into a hollow element that is an injection-molded and/or blow-molded and/or deep-drawn part.

A “deep-drawn part” refers, in the context of the present Application, to those containers that are obtained by deep drawing a first film-like encasing material. Deep drawing is preferably accomplished by placing the encasing material over a receiving recess located in a female die forming the deep-drawing plane, and shaping the encasing material into that receiving recess, is deformed by the action of pressure and/or vacuum. The encasing material can be pretreated before or during shaping, by the action of heat and/or solvents and/or conditioning by way of relative humidities and/or temperatures modified with respect to ambient conditions. The pressure can act by way of two parts of a tool which behave as positive and negative with respect to one another, and which deform a film placed between those tools when pressed together. Also suitable as pressing forces, however, are the action of compressed air and/or the dead weight of the film and/or the dead weight of an active substance placed onto the upper side of the film.

The deep-drawn encasing materials are immobilized after deep drawing, inside the receiving recess and in their three-dimensional shape achieved as a result of the deep-drawing operation, preferably by the use of a vacuum. The vacuum is preferably applied continuously from deep drawing until filling, preferably until sealing, and in particular until the receiving chambers are separated. The use of a discontinuous vacuum, however, for example for deep drawing the receiving chambers and (after an interruption) before and after filling of the receiving chambers, is also possible with comparable success. The continuous or discontinuous vacuum can also vary in its intensity and, for example, assume higher values at the beginning of the method (during deep drawing of the film) than at its end (during filling or sealing or separation).

As already mentioned, the encasing material can be pretreated, before or after shaping into the receiving cavities of the dies, by the action of heat. The encasing material, preferably a water-soluble or water-dispersible polymer film, is heated for up to 5 seconds, preferably for 0.1 to 4 seconds, particularly preferably for 0.2 to 3 seconds, and in particular for 0.4 to 2 seconds, to temperatures above 60° C., preferably above 80° C., particularly preferably between 100 and 120° C., and in particular to temperatures between 105 and 115° C. In order to dissipate this heat, but also in particular to dissipate the heat (e.g. melting) introduced by way of the agents dispensed into the deep-drawn receiving chambers, it is preferred to cool the dies that are used and the receiving recesses located in those dies. Cooling is accomplished by preference to temperatures below 20° C., preferably below 15° C., particularly preferably to temperatures between 2 and 14° C., and in particular to temperatures between 4 and 12° C. The cooling is preferably accomplished continuously, from the beginning of the deep-drawing operation until sealing and separation of the receiving chambers. Cooling fluids, preferably water, which are circulated in special cooling lines within the die, are particularly suitable for cooling.

This cooling, like the continuous or discontinuous application of a vacuum previously described, has the advantage of preventing the deep-drawn receptacles from shrinking back after deep drawing, thereby not only improving the appearance of the product of the method, but at the same time also preventing the emergence, beyond the rim of the receiving chambers, of the agents introduced into the receiving chambers, for example into the sealing regions of the chambers. Problems with sealing the filled chambers are thereby avoided.

With regard to the deep drawing methods, a distinction can be made between methods in which the encasing material is guided horizontally into a shaping station and from there, in horizontal fashion, for filling and/or sealing and/or separation, and methods in which the encasing material is guided over a continuously circulating female die shaping roller (if applicable, optionally having a male die shaping roller, guided in the opposite direction, which guides the shaping plunger to the cavities of the female die shaping roller). The former process variant (the flat-bed process) can be operated both continuously and discontinuously; the process variant using a shaping roller is generally carried out continuously. All the aforesaid deep drawing methods are suitable for production of the agents preferred according to the present invention. The receiving recesses located in the female dies can be arranged “in line” or in offset fashion.

The deep-drawn elements can comprise one, two, three, or more receiving chambers. These receiving chambers can be arranged in the deep-drawn part next to one another and/or one above another. In a preferred embodiment of the present Application, the agent according to the present invention, in particular an automatic dishwashing agent, is packaged in a water-soluble or water-dispersible deep-drawn element that contains, in addition to the solid washing and/or cleaning agent according to the present invention, in particular an automatic dishwashing agent, a liquid or gelled cleaning agent or cleaning agent mixture in a separate receiving chamber.

The water-soluble or water-dispersible containers can be produced not only by deep drawing but also by injection molding. Injection molding refers to the shaping of a shaping compound in such a way that the compound for more than one injection molding operation, contained in a compound cylinder, is plastically softened under the action of heat, and flows under pressure through a nozzle into the hollow chamber of a previously closed tool. The method is applied principally to non-curable shaping compounds that solidify in the tool by cooling. Injection molding is a very economical modern method for producing shaped objects without cutting, and is particularly suited for automated mass production. In practical operation, the thermoplastic shaping compounds (powders, grains, cubes, pastes, etc.) are heated until liquefied (up to 180° C.), and are then injected under high pressure (up to 140 MPa) into closed, preferably water-cooled hollow molds having two parts, i.e. comprising an impression die (formerly called a female die) and a mandrel (formerly called a male die), where they cool and solidify. Piston and screw injection molding machines are usable. Water-soluble polymers such as, for example, the aforementioned cellulose ethers, pectins, polyethylene glycols, polyvinyl alcohols, polyvinylpyrrolidones, alginates, gelatins, or starch, are suitable as shaping compounds (injection-molding compounds).

The washing- or cleaning-agent shaped element and hollow shape are preferably adherently joined to one another along a peripheral sealed seam. Alternatively, of course, adherent joining can also take place along a single sealed seam that is not continuous and that allows the shaped element and the hollow shape to be folded along that sealed seam. Particularly preferred embodiments of this kind of agents according to the present invention are characterized by an advantageous appearance and excellent dispensing flexibility, in particular dispensing via the bleach dispenser or dispensing chambers of washing machines or automatic dishwashers.

Lastly, the shaped element and hollow element can also be adherently joined to one another along two or more sealed seams that are separate from one another.

In a further embodiment, however, the washing- or cleaning-agent shaped element comprises one cavity that encompasses at least portions of the hollow element. Once again, recesses as well as apertures are suitable as cavities; in other words, washing- or cleaning-agent shaped elements in the form of a recess tablet are suitable, as are washing- or cleaning-agent shaped elements in the form of a ring tablet. The water-soluble or water-dispersible hollow elements, which can be adherently joined to the shaped element by a heat-sealed seam, are located at least in part in the cavity. The hollowing elements can, for example, be placed into the cavity, but can also be secured in that cavity by an additional adhesive, latching, or snap-lock connection. In order to minimize the total volume of the washing or cleaning agent according to the present invention, it is preferred that the hollow element fill up at least 50 vol %, preferably at least 70 vol %, particularly preferably at least 80 vol %, and in particular at least 90 vol % of the cavity.

The hollow element preferably comprises a filling, particularly preferably a liquid filling. Very particularly preferred are those liquid fillings that comprise, based in each case on the total weight of the liquid filling, at least 10 wt %, preferably at least 20 wt %, particularly preferably at least 40 wt %, and in particular at least 80 wt % of one or more surfactants.

It has been found that the stability and quality of the heat-sealed seam that joins the washing- or cleaning-agent shaped element to the water-soluble or water-dispersible film material can be influenced by the composition of the washing- or cleaning-agent shaped element. It has proven to be advantageous if the shaped element or the shaped-element phase that is adherently joined by a heat-sealed seam to the water-soluble or water-dispersible film material has a surfactant content below 20 wt %, by preference below 16 wt %, preferably below 12 wt %, particularly preferably below 8 wt %, and in particular below 4 wt %.

The enzyme content, the bleaching-agent content, and the bleach activator content in the shaped element or the shaped-element phase that is adherently joined by the heat-sealed seam to the water-soluble or water-dispersible film material are, like the surfactant content, kept within narrow limits.

Washing or cleaning agents wherein the shaped element or the shaped-element phase that is adherently joined by a heat-sealed seam to the water-soluble or water-dispersible film material has an enzyme content below 6 wt %, by preference below 4.5 wt %, preferably below 3.0 wt %, and in particular below 1.0 wt %, are preferred.

Washing or cleaning agents wherein the shaped element or the shaped-element phase that is adherently joined by a heat-sealed seam to the liquid-filled hollow element has a bleaching-agent content below 15 wt %, by preference below 12 wt %, preferably below 9 wt %, particularly preferably below 6 wt %, and in particular below 3 wt %, are further preferred.

Also particularly advantageous, lastly, are washing or cleaning agents wherein the shaped element or the shaped-element phase that is adherently joined by a heat-sealed seam to the water-soluble or water-dispersible film material has a bleach-activator content below 5 wt %, by preference below 3.5 wt %, particularly preferably below 2.0 wt %, and in particular below 1.0 wt %.

It has furthermore been found that the quality and stability of the heat-sealed seam between the washing- or cleaning-agent shaped element and the water-soluble or water-dispersible film material can be enhanced by increasing the builder content and/or the polymer content of the shaped element or the shaped-element phase that comprises the heat-sealed seam.

Those washing or cleaning agents according to the present invention in which the shaped element or the shaped-element phase that is adherently joined by a heat-sealed seam to the liquid-filled hollow element has a builder content above 10 wt %, by preference above 15 wt %, preferably above 20 wt %, particularly preferably above 25 wt %, and in particular above 30 wt %, are therefore preferred.

Washing or cleaning agents wherein the shaped element or the shaped-element phase that is adherently joined by a heat-sealed seam to the liquid-filled hollow element has a polymer content above 0.5 wt %, preferably above 1.0 wt %, particularly preferably above 2.0 wt %, and in particular above 4 wt %, have also proven to be advantageous.

A further subject of the present invention is a method for manufacturing washing or cleaning agents encompassing at least one washing- or cleaning-agent shaped element and at least one water-soluble or water-dispersible film material, characterized by the steps of:
a) manufacturing washing- or cleaning-agent shaped elements;
b) providing a water-soluble or water-dispersible film material;
c) adherently joining at least one product of step a) to the water-soluble or water-dispersible film material of step b) by means of a heat-sealed seam.

A number of different tools and methods are available to one skilled in the art for the heat sealing of the shaped element and film material.

In a first preferred embodiment, heat sealing is accomplished by the action of heated sealing tools.

In a second preferred embodiment, heat sealing is accomplished by the action of a laser beam.

In a third preferred embodiment, heat sealing is accomplished by the action of hot air.

Heat sealing is accomplished preferably at a temperature above 40° C., particularly preferably above 60° C., very particularly preferably above 80° C., and in particular above 100° C.

Heated for 5 seconds, preferably for 0.1 to 4 seconds, particularly preferably for 0.2 to 3 seconds, and in particular for 0.4 to 2 seconds, to temperatures above 60° C., preferably above 80° C., particularly preferably between 100 and 120° C., and in particular to temperatures between 105 and 115° C.

It is preferred for the washing- or cleaning-agent shaped element to comprise a coating. It is furthermore preferred that the water-soluble or water-dispersible film material made available in step b) be shaped into a hollow element that is an injection-molded and/or blow-molded and/or deep-drawn part.

The washing or cleaning agents according to the present invention are just as usable for textile cleaning as for the cleaning of hard surfaces or dishes.

In addition to the aforesaid substances having washing or cleaning activity, the washing or cleaning agents according to the present invention preferably contain further substances having washing or cleaning activity, in particular substances having washing or cleaning activity from the group of the bleaches, bleach activators, builders, surfactants, enzymes, polymers, disintegration adjuvants, electrolytes, pH adjusting agents, fragrances, perfume carriers, dyes, hydrotropes, foam inhibitors, corrosion inhibitors, and glass corrosion inhibitors. These preferred ingredients are described in more detail below.

Builders

The builders include, in the context of the present invention, in particular the zeolites, silicates, carbonates, organic co-builders, and also (if there are no environmental prejudices against their use) the phosphates.

Suitable crystalline, layered sodium silicates possess the general formula NaMSiₓO₂ₓ₊₁.H₂O, where M denotes sodium or hydrogen, x a number from 1.9 to 4, and y is a number from 0 to 20, and preferred values for x are 2, 3, or 4. Preferred crystalline sheet silicates of the formula indicated above are those in which M denotes sodium and x assumes the value 2 or 3. Both β- and δ-sodium disilicates Na₂Si₂O₅.yH₂O are particularly preferred.

Also usable are amorphous sodium silicates having a Na₂O:SiO₂ modulus from 1:2 to 1:3.3, preferably from 1:2 to 1:2.8, and in particular from 1:2 to 1:2.6, which are dissolution-delayed and exhibit secondary washing properties. Dissolution delay as compared with conventional amorphous sodium silicates can have been brought about in various ways, for example by surface treatment, compounding, compacting/densification, or overdrying. In the context of this invention, the term “amorphous” is also understood to mean “X-amorphous.” In other words, in X-ray diffraction experiments the silicates yield not the sharp X-ray reflections that are typical of crystalline substances, but instead at most one or more maxima in the scattered X radiation, having a width of several degree units of the diffraction angle. Particularly good builder properties can, however, very easily result even if the silicate particles yield blurred or even sharp diffraction maxima in electron beam diffraction experiments. This may be interpreted to mean that the products have microcrystalline regions 10 to several hundred nm in size, values of up to a maximum of 50 nm, and in particular a maximum of 20 nm, being preferred. So-called X-amorphous silicates of this kind likewise exhibit a dissolution delay as compared with conventional water glasses. Densified/compacted amorphous silicates, compounded amorphous silicates, and overdried X-amorphous silicates are particularly preferred.

It is preferred in the context of the present invention that this/these silicate(s), preferably alkali silicates, particularly preferably crystalline or amorphous alkali disilicates, be contained in washing or cleaning agents in quantities from 10 to 60 wt %, preferably 15 to 50 wt %, and in particular 20 to 40 wt %, based in each case on the weight of the washing or cleaning agents.

If the silicates are used as a constituent of automatic dishwashing agents, these agents then preferably contain at least one crystalline layered sodium silicate of the general formula NaMSiₓO₂ₓ₊₁.H₂O, where M represents sodium or hydrogen, x a number from 1.9 to 22, preferably from 1.9 to 4, and y denotes a number from 0 to 33. The crystalline layered silicates of the formula NaMSiₓO₂ₓ₊₁.H₂O are marketed, for example, by Clariant GmbH (Germany) under the trade name Na-SKS, e.g. Na-SKS-1 (Na₂Si₂₂O₄₅.xH₂O, kenyaite), Na-SKS-2 (Na₂Si₁₄O₂₉.xH₂O, magadiite), Na-SKS-3 (Na₂Si₈O₁₇.xH₂O), or Na-SKS-4 (Na₂Si₄O₉.xH₂O, makatite).

Particularly suitable for purposes of the present invention are crystalline layered silicates of formula (I) in which x denotes 2. Especially suitable, of these, are Na-SKS-5 (α-Na₂Si₂O₅), Na-SKS-7 (β-Na₂Si₂O₅, natrosilite), Na-SKS-9 (NaHSi₂O₅.H₂O), Na-SKS-10 (NaHSi₂O₅.3H₂O, kanemite), Na-SKS-11 (t-Na₂Si₂O₅), and Na-SKS-13 (NaHSi₂O₅), but in particular Na-SKS-6 (δ-Na₂Si₂O₅).

If the silicates are used as a constituent of automatic dishwashing agents, those agents contain in the context of the present application a weight portion of the crystalline layered silicate of the formula NaMSiₓO₂ₓ₊₁.H₂O of 0.1 to 20 wt %, preferably 0.2 to 15 wt %, and in particular 0.4 to 10 wt %, based in each case on the total weight of those agents. It is particularly preferred, in particular, if such automatic dishwashing agents comprise a total silicate content below 7 wt %, by preference below 6 wt %, preferably below 5 wt %, particularly preferably below 4 wt %, very particularly preferably below 3 wt %, and in particular below 2.5 wt %, preferably at least 70 wt %, preferably at least 80 wt %, and in particular at least 90 wt % of this silicate, based on the total weight of the silicate content, being silicate having the general formula NaMSiₓO₂ₓ₊₁.yH₂O.

The finely crystalline synthetic zeolite containing bound water that is used is preferably zeolite A and/or zeolite P. Zeolite MAP® (commercial product of the Crosfield Co.) is particularly preferred as zeolite P. Also suitable, however, are zeolite X as well as mixtures of A, X, and/or P. Also commercially available and preferred for use in the context of the present invention is, for example, a co-crystal of zeolite X and zeolite A (approx. 80 wt % zeolite X) that is marketed by CONDEA Augusta S.p.A. under the trade name VEGOBOND AX® and can be described by the formula

nNa₂O.(1-n)K₂O.Al₂O₃.(2-2.5)SiO₂.(3.5-5.5)H₂O

The zeolite can be used both as a builder in a granular compound and as a kind of “dusting” of the entire mixture that is to be compressed, both approaches to incorporating the zeolite into the premixture usually being used. Suitable zeolites exhibit an average particle size of less than 10 μm (volume distribution; measurement method: Coulter Counter), and preferably contain 18 to 22 wt %, in particular 20 to 22 wt %, of bound water.

The use of the generally known phosphates as builder substances is also, of course, possible, provided such use is not to be avoided for environmental reasons. This applies in particular to the use of agents according to the present invention as automatic dishwashing agents, which is particularly preferred in the context of the present application. Among the plurality of commercially available phosphates, the alkali-metal phosphates, with particular preference for pentasodium or pentapotassium triphosphate (sodium or potassium tripolyphosphate), have the greatest significance in the washing- and cleaning-agent industry.

“Alkali-metal phosphates” is the summary designation for the alkali-metal (in particular sodium and potassium) salts of the various phosphoric acids, in which context a distinction can be made between metaphosphoric acids (HPO₃), and orthophosphoric acid H₃PO₄, in addition to higher-molecular-weight representatives. The phosphates offer a combination of advantages: they act as alkali carriers, prevent lime deposits on machine parts and lime encrustations in fabrics, and furthermore contribute to cleaning performance.

Suitable phosphates are, for example, sodium dihydrogenphosphate, NaH₂PO₄, in the form of the dihydrate (density 1.91 gcm⁻³, melting point 60°) or in the form of the monohydrate (density 2.04 gcm⁻³); disodium hydrogenphosphate (secondary sodium phosphate), Na₂HPO₄, which can be used anyhdrously or with 2 mol (density 2.066 gcm⁻³, water lost at 950), 7 mol (density 1.68 gcm⁻³, melting point 480 with loss of 5H₂O), and 12 mol of water (density 1.52 gcm⁻³, melting point 35° with loss of 5H₂O), but in particular trisodium phosphate (tertiary sodium phosphate), Na₃PO₄, which can be used as the dodecahydrate, as the decahydrate (corresponding to 19-20% P₂O₅), and in anhydrous form (corresponding to 3940% P₂O₅).

A further preferred phosphate is tripotassium phosphate (tertiary or tribasic potassium phosphate), K₃PO₄. Also preferred are tetrasodium diphosphate (sodium pyrophosphate), Na₄P₂O₇, which exists in anhydrous form (density 2.534 gcm⁻³, melting point 988°, also indicated as 8800) and as the decahydrate (density 1.815-1.836 gcm⁻³, melting point 940 with loss of water), as well as the corresponding potassium salt potassium diphosphate (potassium pyrophosphate), K₄P₂O₇.

The technically important pentasodium triphosphate Na₅P₃O₁₀ (sodium tripolyphosphate) is a white, water-soluble, non-hygroscopic salt, crystallizing anhydrously or with 6H₂O, of the general formula NaO—[P(O)(ONa)—O]ₙ—Na, where n=3. The corresponding potassium salt, pentapotassium triphosphate K₅P₃O₁₀ (potassium tripolyphosphate), is marketed, for example, in the form of a 50-wt % solution (>23% P₂O₅, 25% K₂O). The potassium polyphosphates are widely used in the washing and cleaning agent industry. Sodium potassium tripolyphosphates also exist and are likewise usable in the context of the present invention. They are produced, for example, when sodium trimetaphosphate is hydrolyzed with KOH:

(NaPO₃)₃+2KOH→Na₃K₂P₃O₁₀+H₂O

These are usable according to the present invention in just the same way as sodium tripolyphosphate, potassium tripolyphosphate, or mixtures of the two; mixtures of sodium tripolyphosphate and sodium potassium tripolyphosphate, or mixtures of potassium tripolyphosphate and sodium potassium tripolyphosphate, or mixtures of sodium tripolyphosphate and potassium tripolyphosphate and sodium potassium tripolyphosphate are also usable according to the present invention.

If phosphates are used in the context of the present Application in washing or cleaning agents as substances having washing or cleaning activity, preferred agents then contain these phosphate(s), preferably alkali-metal phosphate(s), particularly preferably pentasodium or pentapotassium triphosphate (sodium or potassium tripolyphosphate), in quantities from 5 to 80 wt %, preferably 15 to 75 wt %, and in particular 20 to 70 wt %, based in each case on the weight of the washing or cleaning agent.

It is preferred in particular to use potassium tripolyphosphate and sodium tripolyphosphate at a weight ratio of more than 1:1, by preference more than 2:1, preferably more than 5:1, particularly preferably more than 10:1, and in particular more than 20:1. It is particularly preferred to use exclusively potassium tripolyphosphate with no admixtures of other phosphates.

Additional builders are the alkali carriers. Alkali carriers are considered to be, for example, alkali-metal hydroxides, alkali-metal carbonates, alkali-metal hydrogencarbonates, alkali-metal sesquicarbonates, the aforesaid alkali silicates, alkali metasilicates, and mixtures of the aforementioned substances, the alkali carbonates, in particular sodium carbonate, sodium hydrogencarbonate, or sodium sesquicarbonate, being used in preferred fashion for purposes of this invention. A builder system containing a mixture of tripolyphosphate and sodium carbonate is particularly preferred. Likewise particularly preferred is a builder system containing a mixture of tripolyphosphate and sodium carbonate and sodium disilicate. Because of their poor chemical compatibility (as compared with other builder substances) with the other ingredients of washing or cleaning agents, the alkali-metal hydroxides are preferably used only in small quantities, preferably in quantities below 10 wt %, by preference below 6 wt %, particularly preferably below 4 wt %, and in particular below 2 wt %, based in each case on the total weight of the washing or cleaning agent. Agents that, based on their total weight, contain less than 0.5 wt %, and in particular no, alkali-metal hydroxides, are particularly preferred.

It is particularly preferred to use carbonate(s) and/or hydrogencarbonate(s), preferably alkali carbonate(s), particularly preferably sodium carbonate, in quantities from 2 to 50 wt %, preferably 5 to 40 wt %, and in particular 7.5 to 30 wt %, based in each case on the weight of the washing or cleaning agent. Particularly preferred are agents that contain, based on the weight of the washing or cleaning agent (i.e. the total weight of the combination product without package), less than 20 wt %, by preference less than 17 wt %, preferably less than 13 wt %, and in particular less than 9 wt % carbonate(s) and/or hydrogencarbonate(s), preferably alkali carbonates, particularly preferably sodium carbonate.

Polycarboxylates/polycarboxylic acids, polymeric polycarboxylates, aspartic acid, polyacetals, dextrins, further organic co-builders (see below), and phosphonates may be mentioned as organic co-builders. These substance classes are described below.

Usable organic builder substances are, for example, the polycarboxylic acids usable in the form of their sodium salts, “polycarboxylic acids” being understood as those carboxylic acids that carry more than one acid function. These are, for example, citric acid, adipic acid, succinic acid, glutaric acid, malic acid, tartaric acid, maleic acid, fumaric acid, sugar acids, aminocarboxylic acids, nitrilotriacetic acid (NTA), provided such use is not objectionable for environmental reasons, as well as mixtures thereof. Preferred salts are the salts of the polycarboxylic acids such as citric acid, adipic acid, succinic acid, glutaric acid, tartaric acid, sugar acids, and mixtures thereof.

The acids per se can also be used. The acids typically also possess, in addition to their builder effect, the property of an acidifying component, and thus serve also to establish a lower and milder pH for washing or cleaning agents. To be mentioned in this context are, in particular, citric acid, succinic acid, glutaric acid, adipic acid, gluconic acid, and any mixtures thereof.

Further suitable as builders are polymeric polycarboxylates; these are, for example, the alkali-metal salts of polyacrylic acid or polymethacrylic acid, for example those having a relative molecular weight of 500 to 70,000 g/mol.

The molar weights indicated for the polymeric polycarboxylates are, for purposes of this document, weight-averaged molar weights M_{w} of the respective acid form that were determined in principle by means of gel permeation chromatography (GPC), a UV detector having been used. The measurement was performed against an external polyacrylic acid standard that yielded realistic molecular weight values because of its structural relationship to the polymers being investigated. These indications deviate considerably from the molecular weight indications in which polystyrenesulfonic acids are used as a standard. The molar weights measured against polystyrenesulfonic acids are usually much higher than the molar weights indicated in this document.

Suitable polymers are, in particular, polyacrylates that preferably have a molecular weight from 2000 to 20,000 g/mol. Because of their superior solubility, of this group the short-chain polyacrylates that have molar weights from 2000 to 10,000 g/ml, and particularly preferably from 3000 to 5000 g/mol, may in turn be preferred.

Copolymeric polycarboxylates, in particular those of acrylic acid with methacrylic acid and of acrylic acid or methacrylic acid with maleic acid, are also suitable. Copolymers of acrylic acid with maleic acid that contain 50 to 90 wt % acrylic acid and 50 to 10 wt % maleic acid have proven particularly suitable. Their relative molecular weight, based on free acids, is generally 2000 to 70,000 g/mol, preferably 20,000 to 50,000 g/mol, and in particular 30,000 to 40,000 g/mol.

The (co)polymeric polycarboxylates can be used either as a powder or as an aqueous solution. The (co)polymeric polycarboxylate content of the washing or cleaning agents is preferably 0.5 to 20 wt %, in particular 3 to 10 wt %.

To improve water solubility, the polymers can also contain allylsulfonic acids, for example allyloxybenzenesulfonic acid and methallylsulfonic acid, as monomers.

Also particularly preferred are biodegradable polymers made up of more than two different monomer units, for example those that contain salts of acrylic acid and maleic acid, as well as vinyl alcohol or vinyl alcohol derivatives, as monomers, or that contain salts of acrylic acid and of 2-alkylallylsulfonic acid, as well as sugar derivatives, as monomers.

Further preferred copolymers are those that preferably comprise acrolein and acrylic acid/acrylic acid salts, or acrolein and vinyl acetate, as monomers.

Polymeric aminodicarboxylic acids, their salts, or their precursor substances may likewise be mentioned as additional preferred builder substances. Particularly preferred are polyaspartic acids and their salts and.

Further suitable builder substances are polyacetals, which can be obtained by reacting dialdehydes with polyol carboxylic acids having 5 to 7 C atoms and at least three hydroxyl groups. Preferred polyacetals are obtained from dialdehydes such as glyoxal, glutaraldehyde, terephthalaldehyde and mixtures thereof, and from polyol carboxylic acids such as gluconic acid and/or glucoheptonic acid.

Additional suitable organic builder substances are dextrins, for example oligomers or polymers of carbohydrates, which can be obtained by partial hydrolysis of starches. The hydrolysis can be performed using ordinary, for example acid- or enzyme-catalyzed, methods. The hydrolysis products preferably have average molar weights in the range from 400 to 500,000 g/mol. A polysaccharide having a dextrose equivalent (DE) in the range from 0.5 to 40, in particular from 2 to 30, is preferred, DE being a common indicator of the reducing power of a polysaccharide as compared with dextrose, which possesses a DE of 100. Maltodextrins having a DE of between 3 and 20 and dry glucose syrups having a DE of between 20 and 37, as well as so-called yellow dextrins and white dextrins having higher molar weights in the range from 2000 to 30,000 g/mol, are usable.

Relevant oxidized derivatives of such dextrins are their reaction products with oxidizing agents that are capable of oxidizing at least one alcohol function of the saccharide ring to the carboxylic acid function.

Oxydisuccinates and other derivatives of disuccinates, preferably ethylenediaminedisuccinate, are additional suitable cobuilders. Ethylenediamine-N,N′-disuccinate (EDDS) is preferably used in the form of its sodium or magnesium salts. Also preferred in this context are glycerol disuccinates and glycerol trisuccinates. Suitable quantities for use in zeolite- and/or silicate-containing formulations are 3 to 15 wt %.

Further usable organic cobuilders are, for example, acetylated hydroxycarboxylic acids and their salts, which may optionally also be present in lactone form and which contain at least 4 carbon atoms and at least one hydroxy group, as well as a maximum of two acid groups.

All compounds that are capable of forming complexes with alkaline-earth ions can moreover be used as builders.

Surfactants

The group of the surfactants further includes, in addition to the nonionic surfactants described initially, the anionic, cationic, and amphoteric surfactants.

All nonionic surfactants known to one skilled in the art can be used as nonionic surfactants in the context of the present Application. The nonionic surfactants used are preferably alkoxylated, advantageously ethoxylated, in particular primary alcohols having preferably 8 to 18 carbon atoms and an average of 1 to 12 mol ethylene oxide (EO) per mol of alcohol, in which the alcohol radical can be linear or preferably methyl-branched in the 2-position, or can contain mixed linear and methyl-branched radicals, such as those that are usually present in oxo alcohol radicals. Particularly preferred, however, are alcohol ethoxylates having linear radicals made up of alcohols of natural origin having 12 to 18 carbon atoms, e.g. from coconut, palm, tallow, or oleyl alcohol, and an average of 2 to 8 EO per mol of alcohol. The preferred ethyoxylated alcohols include, for example, C₁₂₋₁₄ alcohols with 3 EO or 4 EO, C₉₋₁₁ alcohol with 7 EO, C₁₃₋₁₅ alcohols with 3 EO, 5 EO, 7 EO, or 8 EO, C₁₂₋₁₈ alcohols with 3 EO, 5 EO, or 7 EO, and mixtures thereof, such as mixtures of C₁₂₋₁₄ alcohol with 3 EO and C₁₂₋₁₈ alcohol with 5 EO. The degrees of ethoxylation indicated represent statistical averages, which can be an integer or a fractional number for a specific product. Preferred alcohol ethoxylates exhibit a narrow distribution of homologs (narrow range ethoxylates, NRE). In addition to these nonionic surfactants, fatty alcohols with more than 12 EO can also be used. Examples of these are tallow fatty alcohol with 14 EO, 25 EO, 30 EO, or 40 EO.

Also usable as further nonionic surfactants are alkyl glycosides of the general formula RO(G)ₓ, in which R denotes a primary straight-chain or methyl-branched (in particular methyl-branched in the 2-position) aliphatic radical having 8 to 22, preferably 12 to 18 C atoms; and G is the symbol denoting a glycose unit having 5 or 6 C atoms, preferably glucose. The degree of oligomerization x, which indicates the distribution of monoglycosides and oligoglycosides, is any number between 1 and 10; preferably x is between 1.2 and 1.4.

A further class of nonionic surfactants used in preferred fashion, which are used either as the only nonionic surfactant or in combination with other nonionic surfactants, is alkoxylated, preferably ethoxylated or ethoxylated and propoxylated, fatty acid alkyl esters, preferably having 1 to 4 carbon atoms in the alkyl chain.

Nonionic surfactants of the amine oxide type, for example N-cocalkyl-N,N-dimethylamine oxide and N-tallowalkyl-N,N-dihydroxyethylamine oxide, and the fatty acid alkanolamides, can also be suitable. The quantity of these nonionic surfactants is preferably no more than that of the ethoxylated fatty alcohols, in particular no more than half thereof.

Further suitable surfactants are polyhydroxy fatty acid amides of formula (V)

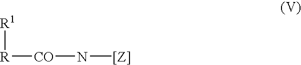

in which RCO denotes an aliphatic acyl radical having 6 to 22 carbon atoms; R¹ denotes hydrogen, an alkyl or hydroxyalkyl radical having 1 to 4 carbon atoms; and [Z] denotes a linear or branched polyhydroxyalkyl radical having 3 to 10 carbon atoms and 3 to 10 hydroxyl groups. The polyhydroxy fatty acid amides are known substances that can usually be obtained by reductive amination of a reducing sugar with ammonia, an alkylamine, or an alkanolamine, and subsequent acylation with a fatty acid, a fatty acid alkyl ester, or a fatty acid chloride.

Also belonging to the group of the polyhydroxy fatty acid amides are compounds of the following formula

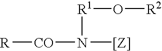

in which R denotes a linear or branched alkyl or alkenyl radical having 7 to 12 carbon atoms; R¹ denotes a linear, branched, or cyclic alkyl radical or an aryl radical having 2 to 8 carbon atoms; and R² denotes a linear, branched, or cyclic alkyl radical or an aryl radical or an oxyalkyl radical having 1 to 8 carbon atoms, C₁₋₄ alkyl or phenyl radicals being preferred; and [Z] denotes a linear polyhydroxyalkyl radical whose alkyl chain is substituted with at least two hydroxyl groups, or alkoxylated, preferably ethoxylated or propoxylated, derivatives of that radical.

[Z] is preferably obtained by reductive amination of a sugar, for example glucose, fructose, maltose, lactose, galactose, mannose, or xylose. The N-alkoxy- or N-aryloxy-substituted compounds can then be converted into the desired polyhydroxy fatty acid amides by reaction with fatty acid methyl esters in the presence of an alkoxide as catalyst.

Low-foaming nonionic surfactants are used as preferred surfactants. Particularly preferably, the cleaning agents according to the present invention for automatic dishwashing contain nonionic surfactants, in particular nonionic surfactants from the group of the alkoxylated alcohols. The nonionic surfactants used are preferably alkoxylated, advantageously ethoxylated, in particular primary alcohols having preferably 8 to 18 C atoms and an average of 1 to 12 mol ethylene oxide (EO) per mol of alcohol, in which the alcohol radical can be linear or preferably methyl-branched in the 2-position, or can contain mixed linear and methyl-branched radicals, such as those that are usually present in oxo alcohol radicals. Particularly preferred, however, are alcohol ethoxylates having linear radicals made up of alcohols of natural origin having 12 to 18 carbon atoms, e.g. from coconut, palm, tallow, or oleyl alcohol, and an average of 2 to 8 EO per mol of alcohol. The preferred ethyoxylated alcohols include, for example, C₁₂₋₁₄ alcohols with 3 EO or 4 EO, C₉₋₁₁ alcohol with 7 EO, C₁₃₋₁₅ alcohols with 3 EO, 5 EO, 7 EO, or 8 EO, C₁₂₋₁₈ alcohols with 3 EO, 5 EO, or 7 EO, and mixtures thereof, such as mixtures of C₁₂₋₁₄ alcohol with 3 EO and C₁₂₋₁₈ alcohol with 5 EO. The degrees of ethoxylation indicated represent statistical averages, which can be an integer or a fractional number for a specific product. Preferred alcohol ethoxylates exhibit a narrow distribution of homologs (narrow range ethoxylates, NRE). In addition to these nonionic surfactants, fatty alcohols with more than 12 EO can also be used. Examples of these are tallow fatty alcohol with 14 EO, 25 EO, 30 EO, or 40 EO.

Additionally claimed with particular preference are, in particular, those automatic dishwashing agents that contain as surfactant(s) one or more tallow fatty alcohols with 20 to 30 EO, in combination with a silicone defoamer.

Nonionic surfactants from the group of the alkoxylated alcohols, particularly preferably from the group of the mixed alkoxylated alcohols, and in particular from the group of the EO-AO-EO nonionic surfactants, are used with particular preference in the context of the present Application.

Particularly preferred are nonionic surfactants that have a melting point above room temperature. Nonionic surfactant(s) having a melting point above 20° C., preferably above 25° C., particularly preferably between 25 and 60° C., and in particular between 26.6 and 43.3° C., are particularly preferred.

Suitable nonionic surfactants that exhibit melting or softening points in the aforesaid temperature range are, for example, low-foaming nonionic surfactants that can be solid or highly viscous at room temperature. If nonionic surfactants that are highly viscous at room temperature are used, it is preferred for them to exhibit a viscosity greater than 20 Pas, preferably greater than 35 Pas, and in particular greater than 40 Pas. Nonionic surfactants that possess a waxy consistency at room temperature are also preferred.

Nonionic surfactants that are solid at room temperature and are preferred for use derive from the groups of the alkoxylated nonionic surfactants, in particular the ethoxylated primary alcohols, and mixtures of these surfactants with structurally more complex surfactants such as polyoxypropylene/polyoxyethylene/polyoxypropylene (PO/EO/PO) surfactants. Such PO/EO/PO nonionic surfactants are moreover characterized by good foam control.

In a preferred embodiment of the present invention, the nonionic surfactant having a melting point above room temperature is an ethoxylated nonionic surfactant that has resulted from the reaction of a monohydroxyalkanol or alkyl phenol having 6 to 20 carbon atoms with preferably at least 12 mol, particularly preferably at least 15 mol, in particular at least 20 mol, of ethylene oxide per mol of alcohol or alkyl phenol.

A nonionic surfactant that is solid at room temperature that is particularly preferred for use is obtained from a straight-chain fatty alcohol having 16 to 20 carbon atoms (C₁₋₂₀ alcohol), preferably a C₁₋₈ alcohol, and at least 12 mol, preferably at least 15 mol, and in particular at least 20 mol of ethylene oxide. Of these, the so-called “narrow range ethoxylates” (see above) are particularly preferred.

It is therefore particularly advantageous to use ethoxylated nonionic surfactants that were obtained from C₆₋₂₀ monohydroxyalkanols or C₆₋₂₀ alkyl phenols or C₁₆₋₂₀ fatty alcohols and more than 12 mol, preferably more than 15 mol, and in particular more than 20 mol ethylene oxide per mol of alcohol.

The nonionic surfactant that is solid at room temperature preferably additionally possesses propylene oxide units in the molecule. Such PO units preferably constitute up to 25 wt %, particularly preferably up to 20 wt %, and in particular up to 15 wt % of the total molar weight of the nonionic surfactant. Particularly preferred nonionic surfactants are ethoxylated monohydroxyalkanols or alkyl phenols that additionally comprise polyoxyethylene-polyoxypropylene block copolymer units. The alcohol or alkyl phenol portion of such nonionic surfactant molecules preferably makes up more than 30 wt %, particularly preferably more than 50 wt %, and in particular more than 70 wt % of the total molar weight of such nonionic surfactants. Preferred agents are characterized in that they contain ethoxylated and propoxylated nonionic surfactants in which the propylene oxide units in the molecule constitute up to 25 wt %, preferably up to 20 wt %, and in particular up to 15 wt % of the total molar weight of the nonionic surfactant.

Additional nonionic surfactants having melting points above room temperature that are particularly preferred for use contain 40 to 70% of a polyoxypropylene/polyoxyethylene/polyoxypropylene block polymer blend that contains 75 wt % of a reverse block copolymer of polyoxyethylene and polyoxypropylene having 17 mol ethylene oxide and 44 mol propylene oxide, and 25 wt % of a block copolymer of polyoxyethylene and polyoxypropylene, initiated with trimethylolpropane and containing 24 mol ethylene oxide and 99 mol propylene oxide per mol of trimethylolpropane.

Nonionic surfactants that can be used with particular preference are obtainable, for example, from Olin Chemicals under the name Poly Tergent® SLF-18.

A further preferred dishwashing agent according to the present invention contains nonionic surfactant(s) of the formula

R¹O[CH₂CH(CH₃)O]ₓ[CH₂CH₂O]_{y}CH₂CH(OH)R²

in which R¹ denotes a linear or branched aliphatic hydrocarbon radical having 4 to 18 carbon atoms, or mixtures thereof; R² a linear or branched hydrocarbon radical having 2 to 26 carbon atoms, or mixtures thereof: and x denotes values between 0.5 and 1.5 and y denotes a value of at least 15.

Additional nonionic surfactants that are usable in preferred fashion are the end-capped poly(oxyalkylated) nonionic surfactants of the formula

R¹O[CH₂CH(R³)O]ₓ[CH₂]ₖCH(OH)[CH₂]ⱼOR²

in which R¹ and R² denote linear or branched, saturated or unsaturated, aliphatic or aromatic hydrocarbon radicals having 1 to 30 carbon atoms; R³ denotes H or a methyl, ethyl, n-propyl, isopropyl, n-butyl, 2-butyl, or 2-methyl-2-butyl radical; x denotes values between 1 and 30; and k and j denote values between 1 and 12, preferably between 1 and 5. If the value of x≧2, each R³ in the formula above can be different. R¹ and R² are preferably linear or branched, saturated or unsaturated, aliphatic or aromatic hydrocarbon radicals having 6 to 22 carbon atoms, radicals having 8 to 18 carbon atoms being particularly preferred. For the R³ radical, H, —CH₃, or —CH₂CH₃ are particularly preferred. Particularly preferred values for x are in the range from 1 to 20, in particular from 6 to 15.

As described above, each R³ in the formula above can be different if x≧2. The alkylene oxide unit in the square brackets can thereby be varied. If, for example, x denotes 3, the R³ radical can be selected so as to form ethylene oxide (R³═H) or propylene oxide (R³═CH₃) units that can be joined onto one another in any sequence, for example (EO)(PO)(EO), (EO)(EO)(PO), (EO)(EO)(EO), (PO)(EO)(PO), (PO)(PO)(EO), and (PO)(PO)(PO). The value of 3 for x was selected as an example here, and can certainly be larger; the range of variation increases with rising values of x, and includes e.g. a large number of (EO) groups combined with a small number of (PO) groups, or vice versa.

Particularly preferred end-capped poly(oxyalkylated) alcohols of the above formula have values of k=1 and j=1, so that the formula above is simplified to

R¹O[CH₂CH(R³)O]ₓCH₂CH(OH)CH₂OR².

In the latter formula, R¹, R², and R³ are as defined above, and x denotes numbers from 1 to 30, preferably from 1 to 20, and in particular from 6 to 18. Surfactants in which the R¹ and R² radicals have 9 to 14 C atoms, R³ denotes H, and x assumes values from 6 to 15, are particularly preferred.

Summarizing what has just been stated, preferred dishwashing agents according to the present invention are those containing end-capped poly(oxyalkylated) nonionic surfactants of the formula

R¹O[CH₂CH(R³)O]ₓ[CH₂]ₖCH(OH)[CH₂]ⱼOR²

in which R¹ and R² denote linear or branched, saturated or unsaturated, aliphatic or aromatic hydrocarbon radicals having 1 to 30 carbon atoms; R³ denotes H or a methyl, ethyl, n-propyl, isopropyl, n-butyl, 2-butyl, or 2-methyl-2-butyl radical; x denotes values between 1 and 30, and k and j denote values between 1 and 12, preferably between 1 and 5, surfactants of the

R¹O[CH₂CH(R³)O]ₓCH₂CH(OH)CH₂OR²

type, in which x denotes numbers from 1 to 30, preferably from 1 to 20, and in particular from 6 to 18, being particularly preferred.

Low-foaming nonionic surfactants that comprise alternating ethylene-oxide and alkylene-oxide units have proven to be particularly preferred nonionic surfactants in the context of the present invention. Among these in turn, surfactants having EO-AO-EO-AO blocks are preferred, one to ten EO or AO groups being bound to one another in each case before being followed by a block of the respectively other groups. Preferred here are automatic dishwashing agents according to the present invention that contain, as nonionic surfactant(s), surfactants of the general formula

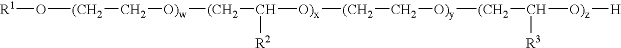

in which R¹ denotes a straight-chain or branched, saturated, or mono- or polyunsaturated C₆₋₂₄ alkyl or alkenyl radical; each R² and R³ group, independently of one another, is selected from —CH₃, —CH₂CH₃, —CH₂CH₂—CH₃, CH(CH₃)₂; and the indices w, x, y, and z denote, independently of one another, integers from 1 to 6.

The preferred nonionic surfactants of the above formula can be produced, using known methods, from the corresponding R¹—OH alcohols and ethylene or alkylene oxide. The R¹ radical in the above formula can vary depending on the derivation of the alcohol. If natural sources are used, the R¹ radical has an even number of carbon atoms and is generally unbranched, the linear radicals from alcohols of natural origin having 12 to 18 carbon atoms, e.g. from coconut, palm, tallow, or oleyl alcohol, being preferred. Alcohols accessible from synthetic sources are, for example, the Guerbet alcohols or radicals methyl-branched in the 2-position or mixed linear and methyl-branched radicals, such as those usually present in oxo alcohol radicals. Regardless of the nature of the alcohol used for production of the nonionic surfactants contained according to the present invention in the agents, automatic dishwashing agents according to the present invention in which R¹ in the above formula denotes an alkyl radical having 6 to 24, preferably 8 to 20, particularly preferably 9 to 15, and in particular 9 to 11 carbon atoms, are preferred.

In addition to propylene oxide, butylene oxide in particular is a possibility as an alkylene oxide unit that is contained, alternatingly with the ethylene oxide unit, in the preferred nonionic surfactants. Further alkylene oxides, in which R² and R³, independently of one another, are selected from —CH₂CH₂—CH₃ or CH(CH₃)₂, are, however also suitable. Preferred automatic dishwashing agents are characterized in that R² and R³ denote a —CH₃ radical; w and x, independently of one another, denote values of 3 or 4; and y and z, independently of one another, denote values of 1 or 2.

In summary, nonionic surfactants that comprise a C₉₋₁₅ alkyl radical having 1 to 4 ethylene oxide units, followed by 1 to 4 propylene oxide units, followed by 1 to 4 ethylene oxide units, followed by 1 to 4 propylene oxide units, are preferred for use in the agents according to the present invention. These surfactants exhibit the necessary low viscosity in aqueous solution, and are usable with particular preference according to the present invention.

Additional nonionic surfactants that are usable in preferred fashion are the end-capped poly(oxyalkylated) nonionic surfactants of the formula

R¹O[CH₂CH(R³)O]ₓR²

in which R¹ denotes linear or branched, saturated or unsaturated, aliphatic or aromatic hydrocarbon radicals having 1 to 30 carbon atoms; R² denotes linear or branched, saturated or unsaturated, aliphatic or aromatic hydrocarbon radicals having 1 to 30 carbon atoms, which preferably comprise between 1 and 5 hydroxy groups and preferably are further functionalized with an ether group; R³ denotes H or a methyl, ethyl, n-propyl, isopropyl, n-butyl, 2-butyl, or 2-methyl-2-butyl radical; and x denotes values between 1 and 40.

Automatic dishwashing agents that contain nonionic surfactants(s) of the general formula

R¹O[CH₂CH(R³)O]ₓR²

in which R¹ denotes linear or branched, saturated or unsaturated, aliphatic or aromatic hydrocarbon radicals having 1 to 30 carbon atoms; R² denotes linear or branched, saturated or unsaturated, aliphatic or aromatic hydrocarbon radicals having 1 to 30 carbon atoms, which preferably comprise between 1 and 5 hydroxy groups and preferably are further functionalized with an ether group; R³ denotes H or a methyl, ethyl, n-propyl, isopropyl, n-butyl, 2-butyl, or 2-methyl-2-butyl radical; and x denotes values between 1 and 40, are likewise preferred.

In a particularly preferred embodiment of the present Application, R³ in the aforesaid general formula denotes H. From the group of the resulting end-capped poly(oxyalkylated) nonionic surfactants of formula

R¹O[CH₂CH₂O]ₓR²

those nonionic surfactants in which R¹ denotes linear or branched, saturated or unsaturated, aliphatic or aromatic hydrocarbon radicals having 1 to 30 carbon atoms, preferably having 4 to 20 carbon atoms; R² denotes linear or branched, saturated or unsaturated, aliphatic or aromatic hydrocarbon radicals having 1 to 30 carbon atoms, which preferably comprise between 1 and 5 hydroxy groups; and x denotes values between 1 and 40, are particularly preferred.

Particularly preferred are those end-capped poly(oxyalkylated) nonionic surfactants that, in accordance with the formula

R¹O[CH₂CH₂O]ₓCH₂CH(OH)R²

in addition to an R¹ radical that denotes linear or branched, saturated or unsaturated, aliphatic or aromatic hydrocarbon radicals having 1 to 30 carbon atoms, preferably having 4 to 20 carbon atoms, additionally comprise a linear or branched, saturated or unsaturated, aliphatic or aromatic hydrocarbon radical having 1 to 30 carbon atoms R², which is adjacent to a monohydroxylated intermediate group —CH₂CH(OH)— and in which x denotes values between 1 and 90.

Particularly preferred in the context of the present Application are those automatic dishwashing agents that contain nonionic surfactant(s) of the general formula

R¹O[CH₂CH₂O]ₓCH₂CH(OH)R²

which, in addition to an R¹ radical that denotes linear or branched, saturated or unsaturated, aliphatic or aromatic hydrocarbon radicals having 1 to 30 carbon atoms, preferably having 4 to 20 carbon atoms, additionally comprise a linear or branched, saturated or unsaturated, aliphatic or aromatic hydrocarbon radical having 1 to 30 carbon atoms R², which is adjacent to a monohydroxylated intermediate group —CH₂CH(OH)— and in which x denotes values between 1 and 90.

The present application claims with particular preference those automatic dishwashing agents that contain nonionic surfactant(s) of the general formula

R¹O[CH₂CH₂O]ₓCH₂CH(OH)R²

which, in addition to an R¹ radical that denotes linear or branched, saturated or unsaturated, aliphatic or aromatic hydrocarbon radicals having 1 to 30 carbon atoms, preferably having 4 to 20 carbon atoms, additionally comprise a linear or branched, saturated or unsaturated, aliphatic or aromatic hydrocarbon radical R² having 1 to 30 carbon atoms, which is adjacent to a monohydroxylated intermediate group —CH₂CH(OH)— and in which x denotes values between 40 and 80, preferably values between 40 and 60.

The corresponding end-capped poly(oxyalkylated) nonionic surfactants of the aforementioned formula can be obtained, for example, by reacting an end-position epoxide of formula R²CH(O)CH₂ with an ethoxylated alcohol of formula R¹O[CH₂CH₂O]ₓ₋₁CH₂CH₂OH.

Also particularly preferred are those end-capped poly(oxyalkylated) nonionic surfactants of the formula

R¹O[CH₂CH(R³)O]ₓCH₂CH(OH)CH₂OR²,

in which R¹ and R², independently of one another, denote a linear or branched, saturated or unsaturated or mono- or polyunsaturated hydrocarbon radical having 2 to 26 carbon atoms; R³ is selected, independently of one another, from —CH₃, —CH₂CH₃, —CH₂CH₂—CH₃, CH(CH₃)₂ but preferably denotes —CH₃; and x and y, independently of one another, denote values between 1 and 32, nonionic surfactants having values for x of 15 to 32 and for y of 0.5 and 1.5 being very particularly preferred.

Automatic dishwashing agents that contain nonionic surfactant(s) of the general formula

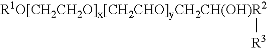

in which R¹ and R², independently of one another, denote a linear or branched, saturated or unsaturated or mono- or polyunsaturated hydrocarbon radical having 2 to 26 carbon atoms; R³ is selected, independently of one another, from —CH₃, —CH₂CH₃, —CH₂CH₂—CH₃, CH(CH₃)₂ but preferably denotes —CH₃; and x and y, independently of one another, denote values between 1 and 32, nonionic surfactants having values for x of 15 to 32 and for y of 0.5 and 1.5 being very particularly preferred, are a constituent of preferred agents according to the present invention in the context of the present Application.

The carbon chain lengths, degrees of ethoxylation, and degrees of alkoxylation indicated for the aforesaid nonionic surfactants constitute statistical averages that may be an integer or a fractional number for a specific product. As a result of production methods, commercial products of the aforesaid formulas are usually made up not of an individual representative, but rather of mixtures, so that average values and, as a consequence, fractional numbers can result both for the carbon chain lengths and for the degrees of ethoxylation and degrees of alkoxylation.

The automatic dishwashing agents according to the present invention can of course contain the aforesaid nonionic surfactants not only as individual substances, but also as surfactant mixtures made up of two, three, four, or more surfactants. “Surfactant mixtures” refers not to mixtures of nonionic surfactants that fall, in their totality, under one of the aforesaid general formulas, but instead to those mixtures containing two, three, four, or more nonionic surfactants that can be described by different ones of the aforesaid general formulas.

Particularly preferred in the context of this Application are automatic dishwashing agents encompassing 0.5 to 12 wt % of a surfactant system made up of
a) at least one nonionic surfactant F of the general formula

R¹—CH(OH)CH₂O-(AO)_{w}-(A′O)ₓ-(A″O)_{y}-(A′″O)_{z}—R², in which
R¹ denotes a straight-chain or branched, saturated or mono- or polyunsaturated C₁₋₂₄ alkyl or alkenyl radical;
R² denotes a linear or branched hydrocarbon radical having 2 to 26 carbon atoms;
A, A′, A″, and A′″, independently of one another, denote a radical from the group —CH₂CH₂, —CH₂CH₂—CH₂, —CH₂—CH(CH₃), —CH₂—CH₂—CH₂—CH₂, —CH₂—CH(CH₃)—CH₂—, —CH₂—CH(CH₂—CH₃),
w, x, y, and z denote values between 0.5 and 25, such that x, y, and/or z can also be 0; and
b) at least one nonionic surfactant G of the general formula

R¹—O-(AO)_{w}-(A′O)ₓ-(A″O)_{y}-(A′″O)_{z}—R² in which
R¹ denotes a straight-chain or branched, saturated or mono- or polyunsaturated C₆₋₂₄ alkyl or alkenyl radical;
R² denotes H or a linear or branched hydrocarbon radical having 2 to 26 carbon atoms;
A, A′, A″, and A′″, independently of one another, denote a radical from the group —CH₂CH₂, —CH₂CH₂—CH₂, —CH₂—CH(CH₃), —CH₂—CH₂—CH₂—CH₂, —CH₂—CH(CH₃)—CH₂—, —CH₂—CH(CH₂—CH₃),
w, x, y, and z denote values between 0.5 and 25, such that x, y, and/or z can also be 0;
the surfactant system comprising nonionic surfactants F and G in a weight ratio F:G of between 1:4 and 100:1.

Particularly preferred in the context of this Application are those automatic dishwashing agents that comprise a surfactant system that encompasses a nonionic surfactant F of the general formula R¹O[CH₂CH₂O]ₓCH₂CH(OH)R² in which R¹ denotes a saturated unbranched aliphatic hydrocarbon radical having 8 to 12 carbon atoms, preferably having 10 carbon atoms; furthermore R² denotes a saturated linear hydrocarbon radical having 8 to 12 carbon atoms, preferably having 8 hydrocarbon radicals; and in which x denotes values between 14 and 26, preferably values from 20 to 24, which is combined with a nonionic surfactant G of the general formula

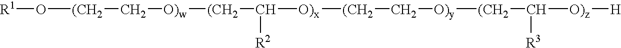

in which R¹ denotes a straight-chain or branched, saturated or mono- or polyunsaturated C₆₋₂₄ alkyl or alkenyl radical; each R² or R³ group, independently of one another, is selected from —CH₃, —CH₂CH₃, —CH₂CH₂—CH₃, CH(CH₃)₂; and the indices w, x, y, z, independently of one another, denote integers from 1 to 6.

Further preferred in the context of this Application are those automatic dishwashing agents that comprise a surfactant system that encompasses a nonionic surfactant F of the general formula R¹O[CH₂CH(CH₃)O]X[CH₂CH₂O]_{y}CH₂CH(OH)R² in which R¹ denotes a saturated unbranched aliphatic hydrocarbon radical having 8 to 12 carbon atoms, preferably having 8 to 10 carbon atoms; furthermore R² denotes a saturated linear hydrocarbon radical having 8 to 12 carbon atoms, preferably having 8 hydrocarbon radicals; and in which x denotes values of 1 or 2, whereas y denotes values between 18 and 24, preferably values from 20 to 24, which is combined with a nonionic surfactant G of the general formula

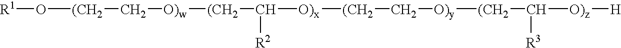

in which R¹ denotes a straight-chain or branched, saturated or mono- or polyunsaturated C₆₋₂₄ alkyl or alkenyl radical; each R² or R³ group, independently of one another, is selected from —CH₃, —CH₂CH₃, —CH₂CH₂—CH₃, CH(CH₃)₂; and the indices w, x, y, z, independently of one another, denote integers from 1 to 6.

Anionic surfactants that can be used are, for example, the sulfonate and sulfate types. Possibilities as surfactants of the sulfonate type are, preferably, C₉₋₁₃ alkyl benzenesulfonates, olefinsulfonates, i.e. mixtures of alkene and hydroxyalkanesulfonates, and disulfonates, for example such as those obtained from C₁₂₋₁₈ monoolefins having an end-located or internal double bond, by sulfonation with gaseous sulfur trioxide and subsequent alkaline or acid hydrolysis of the sulfonation products. Also suitable are alkanesulfonates that are obtained from C₁₂₋₁₈ alkanes, for example by sulfochlorination or sulfoxidation with subsequent hydrolysis and neutralization. The esters of α-sulfo fatty acids (estersulfonates), e.g. the α-sulfonated methyl esters of hydrogenated coconut, palm kernel, or tallow fatty acids, are likewise suitable.

Further suitable anionic surfactants are sulfonated fatty acid glycerol esters. “Fatty acid glycerol esters” are understood as the mono-, di- and triesters, and mixtures thereof, that are obtained during production by the esterification of a monoglycerol with 1 to 3 mol fatty acid, or upon transesterification of triglycerides with 0.3 to 2 mol glycerol. Preferred sulfonated fatty acid glycerol esters are the sulfonation products of saturated fatty acids having 6 to 22 carbon atoms, for example hexanoic acid, octanoic acid, decanoic acid, myristic acid, lauric acid, palmitic acid, stearic acid, or behenic acid.

Preferred alk(en)yl sulfates are the alkali, and in particular sodium, salts of the sulfuric acid semi-esters of the C₁₂-C₁₈ fatty alcohols, for example from coconut fatty alcohol, tallow alcohol, lauryl, myristyl, cetyl, or stearyl alcohol, or the C₁₀-C₂₀ oxo alcohols and those semi-esters of secondary alcohols of those chain lengths. Additionally preferred are alk(en)yl sulfates of the aforesaid chain length that contain a synthetic straight-chain alkyl radical produced on a petrochemical basis, that possess a breakdown behavior analogous to those appropriate compounds based on fat-chemistry raw materials. For purposes of washing technology, the C₁₂-C₁₆ alkyl sulfates and C₁₂-C₁₅ alkyl sulfates, as well as C₁₄-C₁₅ alkyl sulfates, are preferred. 2,3-alkyl sulfates that can be obtained, as commercial products of the Shell Oil Company, under the name DAN® are also suitable anionic surfactants.

The sulfuric acid monoesters of straight-chain or branched C₇₋₂₁ alcohols ethoxylated with 1 to 6 mol ethylene oxide, such as 2-methyl-branched C₉₋₁₁ alcohols with an average of 3.5 mol ethylene oxide (EO) or C₁₂₋₁₈ fatty alcohols with 1 to 4 EO, are also suitable. Because of their high foaming characteristics they are used in cleaning agents only in relatively small quantities, for example in quantities of 1 to 5 wt %.

Other suitable anionic surfactants are also the salts of alkylsulfosuccinic acid, which are also referred to as sulfosuccinates or as sulfosuccinic acid esters and represent the monoesters and/or diesters of sulfosuccinic acid with alcohols, preferably fatty alcohols, and in particular ethyoxylated fatty alcohols. Preferred sulfosuccinates contain C₈₋₁₈ fatty alcohol radicals or mixtures thereof. Particularly preferred sulfosuccinates contain a fatty alcohol radical that is derived from ethoxylated fatty alcohols which, considered per se, represent nonionic surfactants (see below for description). Sulfosuccinates whose fatty alcohol radicals derive from ethoxylated fatty alcohols with a restricted homolog distribution are, in turn, particularly preferred. It is likewise possible to use alk(en)ylsuccinic acid having preferably 8 to 18 carbon atoms in the alk(en)yl chain, or salts thereof.

Further appropriate anionic surfactants are, in particular, soaps. Saturated fatty acid soaps, such as the salts of lauric acid, myristic acid, palmitic acid, stearic acid, hydrogenated erucic acid, and behenic acid, are suitable, as are, in particular, soap mixtures derived from natural fatty acids, e.g. coconut, palm kernel, or tallow fatty acids.

The anionic surfactants, including the soaps, can be present in the form of their sodium, potassium, or ammonium salts, and as soluble salts of organic bases, such as mono-, di-, or triethanolamine. The anionic surfactants are preferably present in the form of their sodium or potassium salts, in particular in the form of the sodium salts.

If the anionic surfactants are a constituent of automatic dishwashing agents, their content, based on the total weight of the agent, is by preference less than 4 wt %, preferably less than 2 wt %, and very particularly preferably less than 1 wt %. Automatic dishwashing agents that contain no anionic surfactants are particularly preferred.

Instead of the aforesaid surfactants or in combination with them, cationic and/or amphoteric surfactants can also be used.

Cationic compounds of the formulas

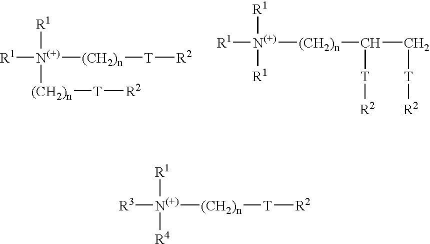

in which each R¹ group, independently of one another, is selected from C₁alkyl, alkenyl, or hydroxyalkyl groups; each R² group, independently of one another, is selected from C₈₋₂₈ alkyl or alkenyl groups; R³═R¹ or (CH₂)ₙ-T-R²; R⁴═R¹ or R² or (CH₂)ₙ-T-R²; T=—CH₂—, —O—CO— or —CO—O—, and n is an integer from 0 to 5, can be used, for example, as cationic active substances.

In automatic dishwashing agents, the cationic and/or amphoteric surfactant content is by preference less than 6 wt %, preferably less than 4 wt %, very particularly preferably less than 2 wt %, and in particular less than 1 wt %. Automatic dishwashing agents that contain no cationic or amphoteric surfactants are particularly preferred.

Polymers

The group of the polymers includes, in particular, the polymers having washing or cleaning activity, for example the clear rinsing polymers and/or polymers effective as softeners. In general, not only nonionic polymers but also cationic, anionic, and amphoteric polymers are also usable in washing and cleaning agents.

“Cationic polymers” for purposes of the present invention are polymers that carry a positive charge in the polymer molecule. This can be implemented, for example, by way of (alkyl)ammonium groups or other positively charged groups present in the polymer chain. Particularly preferred cationic polymers derive from the groups of the quaternized cellulose derivatives, the polysiloxanes having quaternary groups, the cationic guar derivatives, the polymeric dimethyldiallylammonium salts and their copolymers with esters and amides of acrylic acid and methacrylic acid, the copolymers of vinylpyrrolidone with quaternized derivatives of dialkylaminoacrylate and -methacrylate, the vinylpyrrolidone/methoimidazolinium chloride copolymers, the quaternized polyvinylalcohols, or the polymers known under the INCI designations Polyquaternium 2, Polyquaternium 17, Polyquaternium 18, and Polyquaternium 27

“Amphoteric polymers” for purposes of the present additionally comprise, in addition to a positively charged group in the polymer chain, negatively charged groups or monomer units. These groups can be, for example, carboxylic acids, sulfonic acids, or phosphonic acids.

Washing or cleaning agents, in particular automatic dishwashing agents, characterized in that they contain a polymer a) that comprises monomer units of the formula R¹R²C═CR³R⁴ in which each R¹, R², R³, R⁴ radical is selected, independently of one another, from hydrogen, a derivatized hydroxy group, C₁ to C₃₀ linear or branched alkyl groups, aryl, aryl-substituted C₁₋₃₀ linear or branched alkyl groups, polyalkoxylated alkyl groups, heteroatomic organic groups having at least one positive charge without charged nitrogen, at least one quaternized N atom or at least one amino group having a positive charge in the sub-range of the pH range from 2 to 11, or salts thereof, with the stipulation that at least one R¹, R², R³, R⁴ radical is a heteroatomic organic group having at least one positive charge without charged nitrogen, at least one quaternized N atom, or at least one amino group having a positive charge, are particularly preferred in the context of the present Application.

Cationic or amphoteric polymers that are particularly preferred in the context of the present invention contain as a monomer unit a compound of the general formula

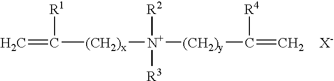

in which R¹ and R⁴, independently of one another, denote H or a linear or branched hydrocarbon radical having 1 to 6 carbon atoms; R² and R³, independently of one another, denote an alkyl, hydroxyalkyl, or aminoalkyl group in which the alkyl radical is linear or branched and comprises between 1 and 6 carbon atoms, this preferably being a methyl group; x and y, independently of one another, denote integers between 1 and 3; X⁻ represents a counterion, preferably a counterion from the group of chloride, bromide, iodide, sulfate, hydrogensulfate, methosulfate, lauryl sulfate, dodecylbenzenesulfonate, p-toluenesulfonate (tosylate), cumenesulfonate, xylenesulfonate, phosphate, citrate, formate, acetate, or mixtures thereof.
Preferred R¹ and R² radicals in the above formula are selected from —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, and —(CH₂CH₂—O)ₙH.

Very particularly preferred in the context of the present Application are polymers that comprise a cationic monomer unit of the above general formula in which R¹ and R⁴ denote H, R² and R³ denote methyl, and x and y are each 1. The corresponding monomer units of formula

H₂C═CH—(CH₂)—N⁺(CH₃)₂—(CH₂)—CH═CH₂X⁻

are also referred to, in the case in which X⁻=chloride, as DADMAC (diallyldimethylammonium chloride).

Further cationic or amphoteric polymers that are particularly preferred in the context of the present Application contain a monomer unit of the general formula

R¹HC═CR²—C(O)—NH—(CH₂)ₓ—N⁺R³R⁴R⁵X⁻

in which R¹, R², R³, R⁴ and R⁵, independently of one another, denote a linear or branched, saturated or unsaturated alkyl or hydroxyalkyl radial having 1 to 6 carbon atoms, preferably a linear or branched alkyl radical selected from —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, and —(CH₂CH₂—O)ₙH, and x denotes a whole number between 1 and 6.
Very particularly preferred in the context of the present Application are polymers that comprise a cationic monomer unit of the above general formula in which R¹ denotes H and R², R³, R⁴, and R⁵ denote methyl, and x denotes 3. The corresponding monomer units of the formula

H₂C═C(CH₃)—C(O)—NH—(CH₂)ₓ—N⁺(CH₃)₃X⁻

are also referred to, in the case where X⁻=chloride, as MAPTAC (methyacrylamidopropyl-trimethylammonium chloride).

Washing or cleaning agents, in particular automatic dishwashing agents, that are preferred according to the present invention are characterized in that polymer a) contains, as monomer units, diallyidimethylammonium salts and/or acrylamidopropyltrimethylammonium salts.

The aforementioned amphoteric polymers comprise not only cationic groups but also anionic groups or monomer units. Anionic monomer units of this kind derive, for example, from the group of the linear or branched, saturated or unsaturated carboxylates, the linear or branched, saturated or unsaturated phosphonates, the linear or branched, saturated or unsaturated sulfates, or the linear or branched, saturated or unsaturated sulfonates. Preferred monomer units are acrylic acid, the (meth)acrylic acids, (dimethyl)acrylic acid, (ethyl)acrylic acid, cyanoacrylic acid, vinylacetic acid, allylacetic acid, crotonic acid, maleic acid, fumaric acid, cinnamic acid and their derivatives, the allylsulfonic acids such as, for example, allyloxybenzenesulfonic acid and methallylsulfonic acid or the allylphosphonic acids.

Amphoteric polymers preferred for use derive from the group of the alkylacrylamide/acrylic acid copolymers, the alkylacrylamide/methacrylic acid copolymers, the alkylacrylamide/methylmethacrylic acid copolymers, the alkylacrylamide/acrylic acid/alkylaminoalkyl(meth)acrylic acid copolymers, the alkylacrylamide/methacrylic acid/alkylaminoalkyl(meth)acrylic acid copolymers, the alkylacrylamide/methylmethacrylic acid/alkylaminoalkyl(meth)acrylic acid copolymers, the alkylacrylamide/alkylmethacrylate/alkylaminoethylmethacrylate/alkylmethacrylate copolymers, and the copolymers of unsaturated carboxylic acids, cationically derivatized unsaturated carboxylic acids and, if applicable, further ionic or nonionogenic monomers.

Zwitterionic polymers preferred for use derive from the group of the acrylamidoalkyltrialkylammonium chloride/acrylic acid copolymers and their alkali and ammonium salts, the acrylamidoalkyltrialkylammonium chloride/methacrylic acid copolymers and their alkali and ammonium salts, and methacroylethylbetaine/methacrylate copolymers.

Also preferred are amphoteric polymers that encompass, in addition to one or more anionic monomers, methacrylamidoalkyltrialkylammonium chloride and dimethyl(diallyl)ammonium chloride as cationic monomers.

Particularly preferred amphoteric polymers derive from the group of the methacrylamidoalkyl-trialkylammonium chloride/dimethyl(diallyl)ammonium chloride/acrylic acid copolymers, the methacrylamidoalkyltrialkylammonium chloride/dimethyl(diallyl)ammonium chloride/methacrylic acid copolymers, and the methacrylamidoalkyltrialkylammonium chloride/dimethyl(diallyl)ammonium chloride/alkyl(meth)acrylic acid copolymers, as well as their alkali and ammonium salts.
Particularly preferred are amphoteric polymers from the group of the methacrylamidopropyltrimethylammonium chloride/dimethyl(diallyl)ammonium chloride/acrylic acid copolymers, the methacrylamidopropyltrimethylammonium chloride/dimethyl(diallyl)ammonium chloride/acrylic acid copolymers, and the methacrylamidopropyltrimethylammonium chloride/dimethyl(diallyl)ammonium chloride/alkyl(meth)acrylic acid copolymers, as well as their alkali and ammonium salts.

In a particularly preferred embodiment of the present invention, the polymers having a molecular weight of 2000 gmol⁻¹ or more contained in the agents according to the present invention are present in prepackaged form. Suitable for packaging of the polymers are, among others:
encapsulation of the polymers by means of water-soluble or water-dispersible coating agents, preferably by means of water-soluble or water-dispersible natural or synthetic polymers;
encapsulation of the polymers by means of water-insoluble meltable coating agents, preferably by means of water-insoluble coating agents from the group of the waxes or paraffins having a melting point above 30° C.;
cogranulation of the polymers with inert carrier materials, preferably with carrier materials from the group of the substances having washing or cleaning activity, particularly preferably from the group of the builders or co-builders.

The agents preferred according to the present invention comprise a weight proportion of the aforesaid polymers of between 0.01 and 10 wt %, based in each case on the total weight of the washing or cleaning agent. Preferred in the context of the present Application, however, are those washing or cleaning agents in which the weight proportion of polymer a) is between 0.01 and 8 wt %, by preference between 0.01 and 6 wt %, preferably between 0.01 and 4 wt %, particularly preferably between 0.01 and 2 wt %, and in particular between 0.01 and 1 wt %, based in each case on the total weight of the automatic dishwashing agent.

Polymers effective as softeners are, for example, the sulfonic acid group-containing polymers, which are used with particular preference.

Particularly preferred for use as sulfonic acid group-containing polymers are copolymers of unsaturated carboxylic acids, sulfonic acid group-containing monomers, and optionally further ionic or nonionogenic monomers.

Preferred as monomers in the context of the present invention are unsaturated carboxylic acids of the formula

R¹(R²)C═C(R³)COOH

in which R¹ to R³, independently of one another, denote —H—CH₃, a straight-chain or branched saturated alkyl radical having 2 to 12 carbon atoms, a straight-chain or branched, mono- or polyunsaturated alkenyl radical having 2 to 12 carbon atoms, alkyl or alkenyl radicals as defined above substituted with —NH₂, —OH, or —COOH, or denote —COOH or —COOR⁴, R⁴ being a saturated or unsaturated, straight-chain or branched hydrocarbon radical having 1 to 12 carbon atoms.

Among the unsaturated carboxylic acids that can be described by the above formula, acrylic acid (R¹═R²═R³═H), methacrylic acid (R¹═R²═H; R³═CH₃) and/or maleic acid (R¹═COOH; R²═R³═H) are particularly preferred.

Preferred in the context of the sulfonic acid group-containing monomers are those of the formula

R⁵(R⁶)C═C(R⁷)—X—SO₃H

in which R⁵ to R⁷, independently of one another, denote —H—CH₃, a straight-chain or branched saturated alkyl radical having 2 to 12 carbon atoms, a straight-chain or branched, mono- or polyunsaturated alkenyl radical having 2 to 12 carbon atoms, alkyl or alkenyl radicals as defined above substituted with —NH₂, —OH, or —COOH, or denote —COOH or —COOR⁴, R⁴ being a saturated or unsaturated, straight-chain or branched hydrocarbon radical having 1 to 12 carbon atoms, and X denotes an optionally present spacer group that is selected from —(CH₂)ₙ— where n=0 to 4, —COO—(CH₂)ₖ— where k=1 to 6, —C(O)—NH—C(CH₃)₂—, and —C(O)—NH—CH(CH₂CH₃)—.

Among these monomers, those of the formulas

H₂C═CH—X—SO₃H

H₂C═C(CH₃)—X—SO₃H

HO₃S—X—(R⁶)C═C(R⁷)—X—SO₃H

in which R⁶ and R⁷, independent of one another, are selected from —H, —CH₃, —CH₂CH₃, —CH₂CH₂CH₃, —CH(CH₃)₂, and X denotes an optionally present spacer group that is selected from —(CH₂)ₙ— where n=0 to 4, —COO—(CH₂)ₖ— where k=1 to 6, —C(O)—NH—C(CH₃)₂—, and —C(O)—NH—CH(CH₂CH₃)—, are preferred.

Particularly preferred sulfonic acid group-containing monomers in this context are 1-acrylamido-1-propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropylacrylate, 3-sulfopropylmethacrylate, sulfomethacrylamide, sulfomethylmethacrylamide, and water-soluble salts of the aforesaid acids.

Ethylenically unsaturated compounds are particularly suitable as further ionic or nonionogenic monomers. The concentration, in the polymers used, of monomers of group iii) is preferably less than 20 wt % based on the polymer. Polymers that are particularly preferred for use are made up only of monomers of groups i) and ii).

In summary, copolymers of
i) unsaturated carboxylic acids of the formula

R¹(R²)C═C(R³)COOH

in which R¹ to R³, independently of one another, denote —H—CH₃, a straight-chain or branched saturated alkyl radical having 2 to 12 carbon atoms, a straight-chain or branched, mono- or polyunsaturated alkenyl radical having 2 to 12 carbon atoms, alkyl or alkenyl radicals as defined above substituted with —NH₂, —OH, or —COOH, or denote —COOH or —COOR⁴, R⁴ being a saturated or unsaturated, straight-chain or branched hydrocarbon radical having 1 to 12 carbon atoms,
ii) sulfonic acid group-containing monomers of the formula

R⁵(R⁶)C═C(R⁷)—X—SO₃H

in which R⁵ to R⁷, independently of one another, denote —H—CH₃, a straight-chain or branched saturated alkyl radical having 2 to 12 carbon atoms, a straight-chain or branched, mono- or polyunsaturated alkenyl radical having 2 to 12 carbon atoms, alkyl or alkenyl radicals as defined above substituted with —NH₂, —OH, or —COOH, or denote —COOH or —COOR⁴, R⁴ being a saturated or unsaturated, straight-chain or branched hydrocarbon radical having 1 to 12 carbon atoms, and X denotes an optionally present spacer group that is selected from —(CH₂)ₙ— where n=0 to 4, —COO—(CH₂)ₖ— where k=1 to 6, —C(O)—NH—C(CH₃)₂—, and —C(O)—NH—CH(CH₂CH₃)—,
iii) optionally, further ionic or nonionogenic monomers
   are particularly preferred.

Further particularly preferred copolymers are made up of
i) one or more unsaturated carboxylic acids from the group of acrylic acid, methacrylic acid, and/or maleic acid
ii) one or more sulfonic acid group-containing monomers of the formulas

H₂C═CH—X—SO₃H

H₂C═C(CH₃)—X—SO₃H

HO₃S—X—(R⁶)C═C(R⁷)—X—SO₃H

in which R⁶ and R⁷, independently of one another, are selected from —H, —CH₃, —CH₂CH₃, —CH₂CH₂CH₃, —CH(CH₃)₂, and X denotes an optionally present spacer group that is selected from —(CH₂)ₙ— where n=0 to 4, —COO—(CH₂)ₖ— where k=1 to 6, —C(O)—NH—C(CH₃)₂—, and —C(O)—NH—CH(CH₂CH₃)—
iii) optionally, further ionic or nonionogenic monomers.

The copolymers can contain the monomers of groups i) and ii), and optionally iii), in varying quantities, in which context all representatives of group i) can be combined with all representatives of group ii) and all representatives of group iii). Particularly preferred polymers comprise specific structural units that are described below.

Preferred, for example, are copolymers that contain structural units of the formula

—[CH₂—CHCOOH]ₘ—[CH₂—CHC(O)—Y—SO₃H]ₚ—

in which m and p each denote a natural whole number between 1 and 2000 and Y denotes a spacer group that is selected from substituted or unsubstituted aliphatic, aromatic, or araliphatic hydrocarbon radicals having 1 to 24 carbon atoms, spacer groups in which Y denotes —O—(CH₂)ₙ— where n=0 to 4, —O—(C₆H₄)—, —NH—C(CH₃)₂—, or —NH—CH(CH₂CH₃)— being preferred.

These polymers are produced by copolymerization of acrylic acid with a sulfonic acid group-containing acrylic acid derivative. If the sulfonic acid group-containing acrylic acid derivative is copolymerized with methacrylic acid, a different polymer is obtained whose use is likewise preferred. The corresponding copolymers contain structural units of the formula

—[CH₂—C(CH₃)COOH]ₘ—[CH₂—CHC(O)—Y—SO₃H]ₚ—

in which m and p each denote a natural whole number between 1 and 2000 and Y denotes a spacer group that is selected from substituted or unsubstituted aliphatic, aromatic, or araliphatic hydrocarbon radicals having 1 to 24 carbon atoms, spacer groups in which Y denotes —O—(CH₂)ₙ— where n=0 to 4, —O—(C₆H₄)—, —NH—C(CH₃)₂—, or —NH—CH(CH₂CH₃)—, being preferred.

Entirely analogously, acrylic acid and/or methacrylic acid can also be copolymerized with sulfonic acid group-containing methacrylic acid derivatives, thereby modifying the structural units in the molecule. Copolymers containing structural units of the formula

—[CH₂—CHCOOH]ₘ—[CH₂—C(CH₃)C(O)—Y—SO₃H]ₚ—

in which m and p each denote a natural whole number between 1 and 2000 and Y denotes a spacer group that is selected from substituted or unsubstituted aliphatic, aromatic, or araliphatic hydrocarbon radicals having 1 to 24 carbon atoms, spacer groups in which Y denotes —O—(CH₂)ₙ— where n=0 to 4, —O—(C₆H₄)—, —NH—C(CH₃)₂—, or —NH—CH(CH₂CH₃)—, are therefore likewise preferred, as are copolymers that structural units of the formula

—[CH₂—C(CH₃)COOH]ₘ—[CH₂—C(CH₃)C(O)—Y—SO₃H]ₚ—

in which m and p each denote a natural whole number between 1 and 2000 and Y denotes a spacer group that is selected from substituted or unsubstituted aliphatic, aromatic, or araliphatic hydrocarbon radicals having 1 to 24 carbon atoms, spacer groups in which Y denotes —O—(CH₂)ₙ— where n=0 to 4, —O—(C₆H₄)—, —NH—C(CH₃)₂—, or —NH—CH(CH₂CH₃)—.

Instead of acrylic acid and/or methacrylic acid or as a supplement thereto, it is also possible to use maleic acid as a particularly preferred monomer of group i). This yields copolymers preferred according to the present invention which contain structural units of the formula

—[HOOCCH—CHCOOH]ₘ—[CH₂—CHC(O)—Y—SO₃H]ₚ—

in which m and p each denote a natural whole number between 1 and 2000 and Y denotes a spacer group that is selected from substituted or unsubstituted aliphatic, aromatic, or araliphatic hydrocarbon radicals having 1 to 24 carbon atoms, spacer groups in which Y denotes —O—(CH₂)ₙ— where n=0 to 4, —O—(C₆H₄)—, —NH—C(CH₃)₂—, or —NH—CH(CH₂CH₃)— being preferred, and copolymers preferred according to the present invention that contain structural units of the formula

—[HOOCCH—CHCOOH]ₘ—[CH₂—C(CH₃)C(O)O—Y—SO₃H]ₚ—

in which m and p each denote a natural whole number between 1 and 2000 and Y denotes a spacer group that is selected from substituted or unsubstituted aliphatic, aromatic, or araliphatic hydrocarbon radicals having 1 to 24 carbon atoms, spacer groups in which Y denotes —O—(CH₂)ₙ— where n=0 to 4, —O—(C₆H₄)—, —NH—C(CH₃)₂—, or —NH—CH(CH₂CH₃)—.

In summary, those copolymers that contain structural units of the formulas

—[CH₂—CHCOOH]ₘ—[CH₂—CHC(O)—Y—SO₃H]ₚ—

—[CH₂—C(CH₃)COOH]ₘ—[CH₂—CHC(O)—Y—SO₃H]ₚ—

—[CH₂—CHCOOH]ₘ—[CH₂—C(CH₃)C(O)—Y—SO₃H]ₚ—

—[CH₂—C(CH₃)COOH]ₘ—[CH₂—C(CH₃)C(O)—Y—SO₃H]ₚ—

—[HOOCCH—CHCOOH]ₘ—[CH₂—CHC(O)—Y—SO₃H]ₚ—

—[HOOCCH—CHCOOH]ₘ—[CH₂—C(CH₃)C(O)O—Y—SO₃H]ₚ—

in which m and p each denote a natural whole number between 1 and 2000 and Y denotes a spacer group that is selected from substituted or unsubstituted aliphatic, aromatic, or araliphatic hydrocarbon radicals having 1 to 24 carbon atoms, spacer groups in which Y denotes —O—(CH₂)ₙ— where n=0 to 4, —O—(C₆H₄)—, —NH—C(CH₃)₂—, or —NH—CH(CH₂CH₃)—, are preferred according to the present invention.

In the polymers, the sulfonic acid groups can be present entirely or partly in neutralized form, i.e. the acid hydrogen atom of the sulfonic acid group can be exchanged, in some or all sulfonic acid groups, for metal ions, preferably alkali-metal ions, and in particular for sodium ions. The use of partly or entirely neutralized sulfonic acid group-containing copolymers is preferred according to the present invention.

The monomer distribution of the copolymers preferably used according to the present invention is, in copolymers that contain only monomers of groups i) and ii), preferably in each case 5 to 95 wt % i) and ii), particularly preferably 50 to 90 wt % of monomer from group i) and 10 to 50 wt % of monomer from group ii), based in each case on the polymer.

In the case of terpolymers, those that contain 20 to 85 wt % of monomer from group i), 10 to 60 wt % of monomer from group ii), and 5 to 30 wt % of monomer from group iii) are particularly preferred.

The molar weight of the sulfo-copolymers preferably used according to the present invention can be varied in order to adapt the properties of the polymers to the desired application. Preferred washing- or cleaning-agent compositions are characterized in that the copolymers exhibit molar weights of 2000 to 200,000 gmol⁻¹, preferably 4000 to 25,000 gmol⁻¹, and in particular 5000 to 15,000 gmol⁻¹.

Bleaching Agents

A preferred constituent of the agent according to the present invention is the bleaching agent. Of the compounds yielding H₂O₂ in water that serve as bleaching agents, sodium percarbonate, sodium perborate tetrahydrate, and sodium perborate monohydrate are of particular importance. Other usable bleaching agents are, for example, peroxypyrophosphates, citrate perhydrates, and peracid salts or peracids that yield H₂O₂, such as perbenzoates, peroxyphthalates, diperazelaic acid, phthaloimino peracid, or diperdodecanedioic acid. Cleaning agents according to the present invention can also contain bleaching agents from the group of the organic bleaching agents. Typical organic bleaching agents are the diacyl peroxides, for example dibenzoyl peroxide. Further typical organic bleaching agents are the peroxy acids, the alkylperoxy acids and arylperoxy acids being mentioned in particular as examples. Preferred representatives are (a) peroxybenzoic acid and its ring-substituted derivatives, such as alkylperoxybenzoic acids but also peroxy-α-naphthoic acid and magnesium monoperphthalate, (b) the aliphatic or substituted aliphatic peroxy acids, such as peroxylauric acid, peroxystearic acid, ε-phthalimidoperoxycaproic acid [phthaloiminoperoxyhexanoic acid (PAP)], o-carboxybenzamindoperoxycaproic acid, N-nonenylamidoperadipic acid, and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyl-di(6-aminopercaproic) acid can be used.

Substances that release chlorine or bromine can also be used as bleaching agents in the dispersions according to the present invention. Appropriate among the materials releasing chlorine or bromine are, for example, heterocyclic N-bromamide and N-chloramides, for example trichloroisocyanuric acid, tribromoisocyanuric acid, dibromoisocyanuric acid, and/or dichloroisocyanuric acid (DICA) and/or their salts with cations such as potassium and sodium. Hydantoin compounds such as 1,3-dichloro-5,5-dimethylhydantoin are also suitable.

Agents according to the present invention, in particular automatic dishwashing agents, characterized in that it contain 1 to 35 wt %, preferably 2.5 to 30 wt %, particularly preferably 3.5 to 20 wt %, and in particular 5 to 15 wt % bleaching agent, preferably sodium percarbonate, are particularly preferred in the context of the present Application.

The active oxygen content of the agents according to the present invention, in particular automatic dishwashing agents, is preferably between 0.4 and 10 wt %, particularly preferably between 0.5 and 8 wt %, and in particular between 0.6 and 5 wt %, based in each case on the total weight of the dishwashing agent. Particularly preferred dishwashing agents exhibit an active oxygen content above 0.3 wt %, preferably above 0.7 wt %, particularly preferably above 0.8 wt %, and in particular above 1.0 wt %.

Bleach Activators

Bleach activators are used, for example, in washing or cleaning agents in order to achieve an improved bleaching effect when cleaning at temperatures of 60° C. and below. Compounds that, under perhydrolysis conditions, yield aliphatic peroxycarboxylic acids having preferably 1 to 10 carbon atoms, in particular 2 to 4 carbon atoms, and/or optionally substituted perbenzoic acid, can be used as bleach activators. Substances that carry the O- and/or N-acyl groups having the aforesaid number of carbon atoms, and/or optionally substituted benzoyl groups, are suitable. Multiply acylated alkylenediamines, in particular tetraacetylethylenediamine (TAED), acylated triazine derivatives, in particular 1,5-diacetyl-2,4-dioxyhexahydro-1,3,5-triazine (DADHT), acylated glycolurils, in particular tetraacetylglycoluril (TAGU), N-acylimides, in particular N-nonanoyl succinimide (NOSI), acylated phenolsulfonates, in particular n-nonanoyl or isononanoyl oxybenzenesulfonate (n- and iso-NOBS), carboxylic acid anhydrides, in particular phthalic acid anhydride, acylated polyvalent alcohols, in particular triacetin, ethylene glycol diacetate, and 2,5-diacetoxy-2,5-dihydrofuran, are preferred.
Further bleach activators preferred for use in the context of the present application are compounds from the group of the cationic nitriles, in particular cationic nitriles of the formula

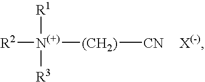

in which R¹ denotes —H, —CH₃, a C₂₋₂₄ alkyl or alkenyl radical, a substituted C₂₋₂₄ alkyl or alkenyl radical having at least one substituent from the group of —Cl, —Br, —OH, —NH₂, —CN, an alkyl or alkenylaryl radical having a C₁₋₂₄ alkyl group, or denotes a substituted alkyl or alkenylaryl radical having a C₁₋₂₄ alkyl group and at least one further substituent on the aromatic ring; R² and R³ are selected, independently of one another, from —CH₂—CN, —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, —(CH₂CH₂—O)ₙH, where n=1, 2, 3, 4, 5 or 6; and X is an anion.

Particularly preferred is a cationic nitrile of the formula

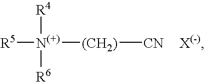

in which R⁴, R⁵ and R⁶ are selected, independently of one another, from —CH₃, —CH₂—CH₃, —CH₂—CH₂—CH₃, —CH(CH₃)—CH₃, where R⁴ can additionally also be —H; and X is an anion, such that preferably R⁵═R⁶=—CH₃ and in particular R⁴═R⁵═R⁶=—CH₃, and compounds of the formulas (CH₃)₃N⁽⁺⁾CH₂—CNX⁻, (CH₃CH₂)₃N⁽⁺⁾CH₂—CNX⁻, (CH₃CH₂CH₂)₃N⁽⁺⁾CH₂—CNX⁻, (CH₃CH(CH₃))₃N⁽⁺⁾CH₂—CNX⁻, or (HO—CH₂—CH₂)₃N⁽⁺⁾CH₂—CNX⁻ are particularly preferred; of the group of these substances, the cationic nitrile of the formula (CH₃)₃N⁽⁺⁾CH₂—CNX⁻, in which X⁻ denotes an anion that is selected from the group of chloride, bromide, iodide, hydrogensulfate, methosulfate, p-toluenesulfonate (tosylate) or such as, for example, Mn, Fe, Co, Ru or Mo salt complexes or carbonyl complexes. Mn, Fe, Co, Ru, Mo, Ti, V and Cu complexes with N-containing tripod ligands, as well as Co, Fe, Cu, and Ru amine complexes, are also usable as bleach catalysts.

If further bleach activators in addition to the nitrilquats are to be used, the bleach activators used are preferably those from the group of the multiply acylated alkylenediamines, in particular tetraacetylethylendiamine (TAED), N-acylimides, in particular N-nonanoylsuccinimide (NOSI), acylated phenolsulfonates, in particular n-nonanoyl- or isononanoyl oxybenzenesulfonate (n- or iso-NOBS), n-methylmorpholinium acetonitrile methyl sulfate (MMA), preferably in quantities up to 10 wt %, in particular 0.1 wt % to 8 wt %, particularly 2 to 8 wt %, and particularly preferably 2 to 6 wt %, based in each case on the total weight of the bleach activator-containing agents.

Bleach-enhancing transition-metal complexes, in particular having the central atoms Mn, Fe, Co, Cu, Mo, V, Ti, and/or Ru xylenesulfonate is selected, is particularly preferred.

Additionally usable as bleach activators are compounds that, under perhydrolysis conditions, yield aliphatic peroxycarboxylic acids having preferably 1 to 10 C atoms, in particular 2 to 4 C atoms, and/or optionally substituted perbenzoic acid. Substances that carry the O- and/or N-acyl groups having the aforesaid number of C atoms, and/or optionally substituted benzoyl groups, are suitable. Multiply acylated alkylenediamines, in particular tetraacetylethylendiamine (TAED), acylated triazine derivatives, in particular 1,5-diacetyl-2,4-dioxyhexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyl oxybenzenesulfonate (n- or iso-NOBS), carboxylic acid anhydrides, in particular phthalic acid anhydrides, acylated polyvalent alcohols, in particular triacetin, ethylene glycol diacetate, 2,5-diacetoxy-2,5-dihydrofuran, n-methylmorpholinium acetonitrile methyl sulfate (MMA), as well as acetylated sorbitol and mannitol and mixtures thereof (SORMAN), acylated sugar derivatives, in particular pentaacetylglucose (PAG), pentaacetylfructose, tetraacetylxylose and octaacetyllactose as well as acylated, optionally N-alkylated glucamine and gluconolactone, and/or N-acylated lactams, for example N-benzoylcaprolactam, are preferred. Hydrophilically substituted acyl acetates and acyl lactams are likewise used in preferred fashion. Combinations of conventional bleach activators can also be used.

In addition to or instead of the conventional bleach activators, so-called bleach catalysts can also be used. These substances are bleach-enhancing transition-metal salts or transition-metal complexes, preferably selected from the group of the manganese and/or cobalt salts and/or complexes, particularly preferably the cobalt(amine) complexes, the cobalt(acetate) complexes, the cobalt(carbonyl) complexes, the chlorides of cobalt or manganese, manganese sulfate, are used in usual quantities, preferably in a quantity up to 5 wt %, in particular from 0.0025 wt % to 1 wt %, and particularly preferably from 0.01 wt % to 0.25 wt %, based in each case on the total weight of the bleach activator-containing agents. In special cases, however, more bleach activator can also be used.

Glass Corrosion Inhibitors

Glass corrosion inhibitors prevent the occurrence of clouding, smearing, or scratching, but also iridescence, on the glass surfaces of automatically washed glasses. Preferred glass corrosion inhibitors derive from the group of the magnesium and/or zinc salts and/or magnesium and/or zinc complexes.

A preferred class of compounds that can be added to the agents according to the present invention in order to prevent glass corrosion is insoluble zinc salts.

Insoluble zinc salts for purposes of this preferred embodiment are zinc salts that possess a solubility of, at maximum, 10 grams of zinc salt per liter of water at 20° C. Examples of insoluble zinc salts that are particularly preferred according to the present invention are zinc silicate, zinc carbonate, zinc oxide, basic zinc carbonate (Zn₂(OH)₂CO₃), zinc hydroxide, zinc oxalate, zinc monophosphate (Zn₃(PO₄)₂), and zinc pyrophosphate (Zn₂(P₂O₇)).

The aforesaid zinc compounds are used preferably in quantities that bring about a zinc ion content in the agents of between 0.02 and 10 wt %, by preference between 0.1 and 5.0 wt %, and in particular between 0.2 and 1.0 wt %, based in each case on the entire glass corrosion inhibitor-containing agent. The agents' exact content of zinc salt or salts is, of course, dependent on the type of zinc salts: the lower the solubility of the zinc salt used, the higher its concentration should be in the agents.

Because the insoluble zinc salts remain for the most part unchanged during the dishwashing process, the particle size of the salts is a criterion requiring care so that the salts do not adhere to glassware or to machine parts. Agents in which the insoluble zinc salts have a particle size below 1.7 millimeters are preferred here.

If the maximum particle size of the insoluble zinc salts is below 1.7 mm, there is no risk of insoluble residues in the dishwasher. In order further to minimize the danger of insoluble residues, the insoluble zinc salt preferably has an average particle size that is well below that value, for example an average particle size of less than 250 μm. This once again is all the more applicable the lower the solubility of the zinc salt. In addition, the glass corrosion-inhibiting effectiveness rises with decreasing particle size. For very poorly soluble zinc salts, the average particle size is preferably below 100 μm. It can be even lower for even more poorly soluble salts; for the very poorly soluble zinc oxide, for example, average particle sizes below 100 μm are preferred.

A further preferred class of compounds is magnesium and/or zinc salt(s) of at least one monomeric and/or polymeric organic acid. The effect of these is that even with repeated use, the surfaces of washed glassware are not modified in corrosive fashion; in particular, no clouding, smearing, or scratching, but also no iridescence of the glass surfaces, are caused.

Although all magnesium and/or zinc salt(s) of monomeric and/or polymeric organic acids can be used, nevertheless, as described above, the magnesium and/or zinc salts of monomeric and/or polymeric organic acids from the groups of the unbranched saturated or unsaturated monocarboxylic acids, the branched saturated or unsaturated monocarboxylic acids, the saturated and unsaturated dicarboxylic acids, the aromatic mono-, di- and tricarboxylic acids, the sugar acids, the hydroxy acids, the oxo acids, the amino acids, and/or the polymeric carboxylic acids are preferred.

The spectrum of the zinc salts of organic acids, preferably of organic carboxylic acids, preferred according to the present invention extends from salts that are poorly soluble or insoluble in water, i.e. exhibit a solubility below 100 mg/L, preferably below 10 mg/L, in particular no solubility, to those salts that exhibit in water a solubility above 100 mg/L, preferably above 500 mg/L, particularly preferably above 1 g/L, and in particular above 5 g/L (all solubilities at a 20° C. water temperature). Zinc citrate, zinc oleate, and zinc stearate, for example, belong to the first group of zinc salts; zinc formate, zinc acetate, zinc lactate, and zinc gluconate, for example, belong to the group of the soluble zinc salts.

With particular advantage, at least one zinc salt of an organic carboxylic acid, particularly preferably a zinc salt from the group of zinc stearate, zinc oleate, zinc gluconate, zinc acetate, zinc lactate, and/or zinc citrate, is used as a glass corrosion inhibitor. Zinc ricinoleate, zinc abietate, and zinc oxalate are also preferred.

In the context of the present invention, the concentration of zinc salt in cleaning agents is by preference between 0.1 and 5 wt %, preferably between 0.2 and 4 wt %, and in particular between 0.4 and 3 wt %, and the concentration of zinc in oxidized form (calculated as Zn²⁺) is between 0.01 and 1 wt %, preferably between 0.02 and 0.5 wt %, and in particular between 0.04 and 0.2 wt %, based in each case on the total weight of the glass corrosion inhibitor-containing agent.

Corrosion Inhibitors

Corrosion inhibitors serve to protect the items being washed or the machine, silver protection agents having particular importance in the automatic dishwashing sector. The known substances of the existing art are usable. In general, silver protection agents can be selected principally from the group of the triazoles, benzotriazoles, bisbenzotriazoles, aminotriazoles, alkylaminotriazoles, and transition-metal salts or complexes. Benzotriazole and/or alkylaminotriazole are particularly preferred for use. The following can be mentioned as examples of the 3-amino-5-alkyl-1,2,4-triazoles preferred for use according to the present invention: 5-propyl-, butyl-, pentyl-, heptyl-, octyl-, nonyl-, decyl-, undecyl-, dodecyl-, isononyl-, versatic-10 acid alkyl-, phenyl-, p-tolyl-, (4-tert.butylphenyl)-, (4-methoxyphenyl)-, (2-, 3-, 4-pyridyl)-, (2-thienyl)-, (5-methyl-2-furyl)-, (5-oxo-2-pyrrolidinyl)-, 3-amino-1,2,4-triazole. In dishwashing agents, the alkylamino-1,2,4-triazoles or their physiologically acceptable salts are used at a concentration of 0.001 to 10 wt %, preferably 0.0025 to 2 wt %, particularly preferably 0.01 to 0.04 wt %. Preferred acids for salt formation are hydrochloric acid, sulfuric acid, phosphoric acid, carbonic acid, sulfurous acid, organic carboxylic acids such as acetic, glycolic, citric, succinic acid. 5-pentyl, 5-heptyl, 5-nonyl, 5-undecyl, 5-isononyl, 5-versatic-10 acid alkyl-3-amino-1,2,4-triazoles, and mixtures of these substances, are very particularly effective.

Cleaner formulations moreover often comprise agents containing active chlorine, which agents can greatly decrease the corrosion of silver surfaces. In chlorine-free cleaners, oxygen- and nitrogen-containing organic redox-active compounds are used in particular, such as di- and trivalent phenols, e.g. hydroquinone, catechol, hydroxyhydroquinone, gallic acid, phloroglucine, pyrogallol, and derivatives of these classes of compounds. Salt-like and complex-like inorganic compounds, for example salts of the metals Mn, Ti, Zr, Hf, V, Co, and Ce, are also often used. Preferred in this context are the transition-metal salts that are selected from the group of the manganese and/or cobalt salts and/or complexes, particularly preferably the cobalt(amine) complexes, cobalt(acetate) complexes, cobalt(carbonyl) complexes, the chlorides of cobalt or manganese, and manganese sulfate. Zinc compounds can also be used to prevent corrosion of the items being washed.

Instead of or in addition to the silver protection agents described above, for example the benzotriazoles, redox-active substances can be used in the dispersions according to the present invention. These substances are preferably contains inorganic redox-active substances from the group of the manganese, titanium, zirconium, hafnium, vanadium, cobalt, and cerium salts and/or complexes, the metals preferably being present in one of the oxidation stages II, III, IV, V, or VI.

The metal salts or metal complexes that are used should be at least partially soluble in water. The counterions suitable for salt formation comprise all usual singly, doubly, or triply negatively charged inorganic anions, e.g. oxide, sulfate, nitrate, fluoride, but also organic anions such as, for example, stearate.

Metal complexes for purposes of the invention are compounds that comprise a central atom and one or more ligands, as well as, if applicable, additionally one or more of the aforementioned anions. The central atom is one of the aforementioned metals in one of the aforementioned oxidation stages. The ligands are neutral molecules or anions that are unidentate or multidentate; the term “ligand” for purposes of the invention is explained in more detail in, for example, “Römpp Chemie Lexikon,” Georg Thieme Verlag Stuttgart/New York, 9th edition, 1990, page 2507. If the charge of the central atom and the charge of the ligand(s) in a metal complex do not add up to zero, charge equalization is ensured by either one or more of the aforementioned anions or one or more cations, e.g. sodium, potassium, ammonium ions, depending on whether a cationic or anionic charge excess exists. Suitable complexing agents are, for example, citrate, acetyl acetonate, or 1-hydroxyethane-1,1-diphosphonate.

The definition of “oxidation stage” commonly used in chemistry is provided, for example, in “Römpp Chemie Lexikon,” Georg Thieme Verlag Stuttgart/New York, 9th edition, 1991, page 3168.

Particularly preferred metal salts and/or metal complexes are selected from the group of MnSO₄, Mn(II) citrate, Mn(II) stearate, Mn(II) acetyl acetonate, Mn(II)-[1-hydroxyethane-1,1-diphosphonate], V₂O₅, V₂O₄, VO₂, TiOSO₄, K₂TiF₆, K₂ZrF₆, CoSO₄, Co(NO₃)₂, Ce(NO₃)₃ and mixtures thereof, so that preferred automatic dishwashing agents according to the present invention are characterized in that the metal salts and/or metal complexes are selected from the group of MnSO₄, Mn(II) citrate, Mn(II) stearate, Mn(II) acetyl acetonate, Mn(II) [1-hydroxyethane-1,1-diphosphonate], V₂O₅, V₂O₄, VO₂, TiOSO₄, K₂TiF₆, K₂ZrF₆, CoSO₄, Co(NO₃)₂, Ce(NO₃)₃.

These metal salts or metal complexes are, in general, commercially available substances that can be used without prior purification in agents according to the present invention for purposes of silver corrosion protection. For example, the mixture of pentavalent and tetravalent vanadium (V₂O₅, VO₂, V₂O₄) known from SO₃ production (contact method) is suitable, as is the titanyl sulfate TiOSO₄ resulting from dilution of a Ti(SO₄)₂ solution.

The inorganic redox-active substances, in particular metal salts or metal complexes, are preferably coated, i.e. completely covered with a material that is watertight but easily soluble at cleaning temperatures, in order to prevent their premature decomposition or oxidation during storage. Preferred coating materials, which are applied using known methods, e.g. Sandwik melt-coating methods from the food industry, are paraffins, microcrystalline waxes, waxes of natural origin such as carnauba wax, candellila wax, beeswax, higher-melting-point alcohols such as, for example, hexadecanol, soaps, or fatty acids. The coating material, which is solid at room temperature, is applied in the molten state onto the material to be coated, for example by shooting fine particles of material to be coated, in a continuous stream, through a likewise continuously generated spray-mist zone of the molten coating material. The melting point must be selected so that the coating material does not easily dissolve or rapidly melt during silver treatment. The melting point should ideally be in the range between 45° C. and 65° C., and preferably in the range 50° C. to 60° C.

The aforesaid metal salts and/or metal complexes are used in cleaning agents by preference in a quantity from 0.05 to 6 wt %, preferably 0.2 to 2.5 wt %, based in each case on the total corrosion inhibitor-containing agent.

Enzymes

Enzymes are usable in order to enhance the washing or cleaning performance of washing or cleaning agents. They include, in particular, proteases, amylases, lipases, hemicellulases, cellulases, or oxidoreductases, as well as preferably mixtures thereof. These enzymes are, in principle, of natural origin; improved variants based on the natural molecules are available for use in washing and cleaning agents and are correspondingly preferred for use. Agents according to the present invention contain enzymes preferably in total quantities from 1×10⁻⁶ to 5 wt %, based on active protein. The protein concentration can be determined with known methods, for example the BCA method or the biuret method.

Among the proteases, those of the subtilisin type are preferred. Examples thereof are the subtilisins BPN′ and Carlsberg, protease PB92, subtilisins 147 and 309, the alkaline protease from Bacillus lentus, subtilisin DY, and the enzymes (to be classified, however, as subtilases and no longer as subtilisins in the strict sense) thermitase, proteinase K, and proteases TW3 and TW7. Subtilisin Carlsberg is obtainable in further developed form under the trade name Alcalase® from Novozymes A/S, Bagsværd, Denmark. Subtilisins 147 and 309 are marketed by Novozymes under the trade names Esperase® and Savinase®, respectively. The variants listed under the designation BLAP® are derived from the protease from Bacillus lentus DSM 5483.

Other usable proteases are, for example, the enzymes obtainable under the trade names Durazym®, Relase®, Everlase®, Nafizym, Natalase®, Kannase®, and Ovozymes® from Novozymes, under the trade names Purafect®, Purafect® OxP and Properase® from Genencor, under the trade name Protosol® from Advanced Biochemicals Ltd., Thane, India, under the trade name Wuxi® from Wuxi Snyder Bioproducts Ltd., China, under the trade names Proleather® and Protease P® from Amano Pharmaceuticals Ltd., Nagoya, Japan, and under the designation Proteinase K-16 from Kao Corp., Tokyo, Japan.

Examples of amylases usable according to the present invention are the α-amylases from Bacillus lichenifonnis, from B. amyloliquefaciens, or from B. stearothermophilus, and their further developments improved for use in washing and cleaning agents. The enzyme from B. licheniformus is available from Novozymes under the name Termamyl®, and from Genencor under the name Purastar® ST. Further developed products of these α-amylases are available from Novozymes under the trade names Duramyl® and Termamyl® ultra, from Genencor under the name Purastar® OxAm, and from Daiwa Seiko Inc., Tokyo, Japan, as Keistase®. The α-amylase from B. amyloliquefaciens is marketed by Novozymes under the name BAN®, and derived variants of the α-amylase from B. stearothermophilus are marketed, again by Novozymes, under the names BSG® and Novamyl®.

Additionally to be highlighted for this purpose are the α-amylase from Bacillus sp. A 7-7 (DSM 12368) and the cyclodextrin-glucanotransferase (CGTase) from B. agaradherens (DSM 9948).

The further developments of the α-amylase from Aspergillus niger and A. oryzae, obtainable from Novozymes under the trade names Fungamyl®, are also suitable. A further commercial product is, for example, Amylase-LT®.

Additionally usable according to the present invention are lipases or cutinases, in particular because of their triglyceride-cleaving activities but also in order to generate peracids in situ from suitable precursors. These include, for example, the lipases obtainable originally from Humicola lanuginosa (Thermomyces lanuginosus) or further developed lipases, in particular those having the D96L amino-acid exchange. They are marketed, for example, by Novozymes under the trade names Lipolase®, Lipolase® Ultra, LipoPrime®, Lipozyme®, and Lipex®. The cutinases that were originally isolated from Fusarum solani pisi and Humicola insolens are moreover usable. Usable lipases are likewise obtainable from Amano under the designations Lipase CE®, Lipase P®, Lipase B®, or Lipase CES®, Lipase AKG®, Bacillis sp. Lipase®, Lipase AP®, Lipase M-AP®, and Lipase AML®. The lipases and cutinases from, for example, Genencor, whose starting enzymes were originally isolated from Pseudomonas mendocina and Fusarium solanii, are usable. To be mentioned as further important commercial products are the preparations M1 Lipase® and Lipomax® originally marketed by Gist-Brocades, and the enzymes marketed by Meito Sangyo KK, Japan, under the names Lipase MY-30®, Lipase OF®, and Lipase PL®, as well as the Lumafast® product of Genencor.

It is furthermore possible to use enzymes that are grouped under the term “hemicellulases.” These include, for example, mannanases, xanthanlyases, pectinlyases (=pectinases), pectinesterases, pectatelyases, xyloglucanases (=xylanases), pullulanases, and β-glucanases. Suitable mannanases are obtainable, for example, under the names Gamanase® and Pektinex AR® from Novozymes, under the name Rohapec® B1L from AB Enzymes, and under the name Pyrolase® from Diversa Corp., San Diego, Calif., USA. The β-glucanase obtained from B. subtilis is available under the name Cereflo® from Novozymes.

To enhance the bleaching effect, oxidoreductases, for example oxidases, oxygenases, catalases, peroxidases such as halo-, chloro-, bromo-, lignin, glucose, or manganese peroxidases, dioxygenases, or laccases (phenoloxidases, polyphenoloxidases) can be used according to the present invention. Suitable commercial products that may be mentioned are Denilite® 1 and 2 of Novozymes. Advantageously, preferably organic, particularly preferably aromatic compounds that interact with the enzymes are additionally added in order to enhance the activity of the relevant oxidoreductases (enhancers) or, if there is a large difference in redox potentials between the oxidizing enzymes and the dirt particles, to ensure electron flow (mediators).

The enzymes derive, for example, either originally from microorganisms, for example the genera Bacillus, Streptomyces, Humicola, or Pseudomonas, and/or are produced by suitable microorganisms in accordance with biotechnological methods known per se, for example by transgenic expression hosts of Bacillus genera or filamentous fungi.

Purification of the relevant enzymes is preferably accomplished by way of methods established per se, for example by precipitation, sedimentation, concentration, filtration of the liquid phases, microfiltration, ultrafiltration, the action of chemicals, deodorization, or suitable combinations of these steps.

The enzymes can be used in any form established according to the existing art. These include, for example, the solid preparations obtained by granulation, extrusion, or lyophilization or, especially in the case of liquid or gelled agents, solutions of the enzymes, advantageously as concentrated as possible, anhydrous, and/or with stabilizers added.

Alternatively, the enzymes can be encapsulated for both the solid and the liquid administration form, for example by spray-drying or extrusion of the enzyme solution together with a preferably natural polymer, or in the form of capsules, for example ones in which the enzyme is enclosed e.g. in a solidified gel, or in those of the core-shell type, in which an enzyme-containing core is covered with a protective layer impermeable to water, air, and/or chemicals. Further ingredients, for example stabilizers, emulsifiers, pigments, bleaching agents, or dyes, can additionally be applied in superimposed layers. Such capsules are applied in accordance with methods known per se, for example by vibratory or rolling granulation or in fluidized-bed processes. Such granulated materials are advantageously low in dust, e.g. as a result of the application of polymer film-forming agents, and are stable in storage thanks to the coating.

It is additionally possible to formulate two or more enzymes together, so that a single granulated material has several enzyme activities.

A protein and/or enzyme can be protected, especially during storage, against damage such as, for example, inactivation, denaturing, or decomposition, e.g. resulting from physical influences, oxidation, or proteolytic cleavage. An inhibition of proteolysis is particularly preferred in the context of microbial recovery of the proteins and/or enzymes, in particular when the agents also contain proteases. Agents according to the present invention can contain stabilizers for this purpose; the provision of such agents represents a preferred embodiment of the present invention.

Reversible protease inhibitors are one group of stabilizers. Benzamidine hydrochloride, borax, boric acids, boronic acids, or their salts or esters are often used, among them principally derivatives having aromatic groups, e.g. ortho-substituted, meta-substituted, and para-substituted phenylboronic acids, or their salts or esters. Ovomucoid and leupeptin may be mentioned as peptide protease inhibitors; an additional option is the creation of fusion proteins from proteases and peptide inhibitors.

Further enzyme stabilizers are aminoalcohols such as mono-, di-, triethanol- and -propanolamine and mixtures thereof, aliphatic carboxylic acids up to C₁₂ such as succinic acid, other dicarboxylic acids, or salts of the aforesaid acids. End-capped fatty acid amide alkoxylates are also suitable. Certain organic acids used as builders are additionally capable of stabilizing a contained enzyme.

Lower aliphatic alcohols, but principally polyols, for example glycerol, ethylene glycol, propylene glycol, or sorbitol, are other frequently used enzyme stabilizers. Calcium salts are likewise used, for example calcium acetate or calcium formate, and magnesium salts.

Polyamide oligomers or polymeric compounds such as lignin, water-soluble vinyl copolymers or cellulose ethers, acrylic polymers, and/or polyamides stabilize the enzyme preparation, inter alia, with respect to physical influences or pH fluctuations. Polyamine-N-oxide-containing polymers act as enzyme stabilizers. Other polymeric stabilizers are the linear C₈-C₁₈ polyoxyalkylenes. Alkylpolyglycosides can stabilize the enzymatic components of the agent according to the present invention, and even improve its performance. Crosslinked nitrogen-containing compounds likewise function as enzyme stabilizers.

Reducing agents and antioxidants increase the stability of the enzymes with respect to oxidative breakdown. One sulfur-containing reducing agent is, for example, sodium sulfite.

Combinations of stabilizers are preferably used, for example made up of polyols, boric acid and/or borax, the combination of boric acid or borate, reducing salts, and succinic acid or other dicarboxylic acids, or the combination of boric acid or borate with polyols or polyamino compounds and with reducing salts. The effect of peptide aldehyde stabilizers is increased by the combination with boric acid and/or boric acid derivatives and polyols, and further enhanced by the additional use of divalent cations, for example calcium ions.

Preferably one or more enzymes and/or enzyme preparations, preferably solid protease preparations and/or amylase preparations, are used in quantities from 0.1 to 5 wt %, preferably 0.2 to 4.5 wt %, and in particular 0.4 to 4 wt %, based in each case on the entire enzyme-containing agent.

Disintegration Adjuvants

In order to facilitate the breakdown of prefabricated shaped elements, it is possible to incorporate disintegration adjuvants, so-called tablet bursting agents, into those agents in order to shorten breakdown times. Tablet bursting agents or breakdown accelerators are understood, in accordance with Römpp (9th ed., Vol. 6, p. 4440) and Voigt “Lehrbuch der pharmazeutischen Technologie” [Textbook of pharmaceutical technology] (6th ed., 1987, pp. 182-184) as auxiliaries that ensure the rapid breakdown of tablets in water or gastric juice, and the release of drugs in resorbable form.

These substances, which are also referred to as “bursting” agents because of their action, increase in volume upon the entry of water; on the one hand, their own volume is increased (swelling), and on the other hand the release of gases can also generate a pressure that allows the tablets to break down into smaller particles. Familiar disintegration adjuvants are, for example, carbonate/citric acid systems; other organic acids can also be used. Swelling disintegration adjuvants are, for example, synthetic polymers such as polyvinylpyrrolidone (PVP), or natural polymers or modified natural substances such as cellulose and starch and their derivates, alginates, or casein derivatives.

Disintegration adjuvants are used preferably in quantities of 0.5 to 10 wt %, by preference 3 to 7 wt %, and in particular 4 to 6 wt %, based in each case on the total weight of the agent containing the disintegration adjuvant.

Cellulose-based disintegration agents are used as preferred disintegration agents in the context of the present invention, so that preferred washing and cleaning agent compositions contain such a cellulose-based disintegration agent in quantities from 0.5 to 10 wt %, preferably 3 to 7 wt %, and in particular 4 to 6 wt %. Pure cellulose has the formal gross composition (C₆H₁₀O₅)ₙ, and in formal terms constitutes a β-1,4-polyacetal of cellobiose, which in turn is made up of two molecules of glucose. Suitable celluloses comprise approx. 500 to 5000 glucose units, and consequently have average molar weights of 50,000 to 500,000. Also usable in the context of the present invention as cellulose-based disintegration agents are cellulose derivatives that are obtainable from cellulose via polymer-analogous reactions. Such chemically modified celluloses comprise, for example, products of esterification or etherification processes in which hydroxy hydrogen atoms were substituted. Celluloses in which the hydroxy groups were replaced with functional groups that are not bound via an oxygen atom can also, however, be used as cellulose derivatives. The group of the cellulose derivatives embraces, for example, alkali celluloses, carboxymethyl cellulose (CMC), cellulose esters and ethers, and aminocelluloses. The aforesaid cellulose derivatives are preferably not used as the only cellulose-based disintegration agent, but are utilized mixed with cellulose. The cellulose-derivative content of these mixtures is preferably below 50 wt %, particularly preferably below 20 wt %, based on the cellulose-based disintegration agent. Pure cellulose that is free of cellulose derivatives is particularly preferred for use as a cellulose-based disintegration agent.

The cellulose used as a disintegration adjuvant is preferably used not in finely divided form, but instead is converted into a coarser form, for example granulated or compacted, before being mixed into the premixtures that are to be compressed. The particle sizes of such disintegration agents are usually above 200 μm, preferably at least 90 wt % between 300 and 1600 μm, and in particular at least 90 wt % between 400 and 1200 μm. The aforesaid coarser cellulose-based disintegration adjuvants mentioned above and described in more detail in the referenced documents are preferable for use as disintegration adjuvants in the context of the present invention, and obtainable commercially, for example, under the designation Arbocel® TF-30-HG of the Rettenmaier company.

Microcrystalline cellulose can be used as a further cellulose-based disintegration agent or as a constituent of those components. This microcrystalline cellulose is obtained by partial hydrolysis of celluloses under conditions such that only the amorphous regions (approx. 30% of the total cellulose mass) of the celluloses are attacked and dissolve completely, but the crystalline regions (approx. 70%) remain undamaged. A subsequent disaggregation of the microfine celluloses produced by hydrolysis yields the microcrystalline celluloses, which have primary particle sizes of approx. 5 μm and are compactable, for example, into granulates having an average particle size of 200 μm.

Disintegration adjuvants preferred in the context of the present invention, preferably a cellulose-based disintegration adjuvant, preferably in granular, co-granulated, or compacted form, are contained in the agents containing the disintegration agents in quantities from 0.5 to 10 wt %, preferably from 3 to 7 wt %, and in particular from 4 to 6 wt %, based in each case on the total weight of the agent containing the disintegration agent.

Gas-evolving effervescence systems can furthermore be used as tablet disintegration adjuvants in a manner preferred according to the present invention. The gas-evolving effervescence system can be made up of a single substance that releases a gas upon contact with water. To be mentioned among these compounds is, in particular, magnesium peroxide, which releases oxygen upon contact with water. Usually, however, the gas-releasing bubbling system is in turn made up of at least two constituents that react with one another to form gas. While a plurality of systems that release, for example, nitrogen, oxygen, or hydrogen are conceivable and implementable here, the bubbling system used in the washing and cleaning agent compositions according to the present invention will be selected with regard to both economic and environmental considerations. Preferred effervescence systems comprise alkali-metal carbonate and/or hydrogencarbonate as well as an acidifying agent that is suitable for releasing carbon dioxide from the alkali-metal salts in aqueous solution.

Among the alkali-metal carbonates or hydrogencarbonates, the sodium and potassium salts are greatly preferred over the other salts for cost reasons. It is of course not necessary for the relevant pure alkali-metal carbonates or hydrogencarbonates to be used; mixtures of different carbonates and hydrogencarbonates can instead be preferred.

Preferably 2 to 20 wt %, by preference 3 to 15 wt %, and in particular 5 to 10 wt % of an alkali-metal carbonate or hydrogencarbonate, as well as 1 to 15, preferably 2 to 12, and in particular 3 to 10 wt % of an acidifying agent, based in each case on the total weight of the agent, are used as an effervescence system.

Boric acid, as well as alkali-metal hydrogensulfates, alkali-metal dihydrogenphosphates, and other inorganic salts are usable, for example, as acidifying agents that release carbon dioxide from the alkali salts in aqueous solution. Organic acidifying agents are preferably used, however, citric acid being a particularly preferred acidifying agent. Also usable in particular, however, are the other solid mono-, oligo-, and polycarboxylic acids. Of this group, tartaric acid, succinic acid, malonic acid, adipic acid, maleic acid, fumaric acid, oxalic acid, and polyacrylic acid are in turn preferred. Organic sulfonic acids such as amidosulfonic acid are likewise usable. Sokalan® DCS (trademark of BASF), a mixture of succinic acid (max. 31 wt %), glutaric acid (max. 50 wt %) and adipic acid (max. 33 wt %), is commercially obtainable and likewise preferably usable as an acidifying agent in the context of the present invention.

Acidifying agents in the effervescence system from the group of the organic di-, tri-, and oligocarboxylic acids, or mixtures, are preferred in the context of the present invention.

Fragrances

Individual aroma compounds, e.g. the synthetic products of the ester, ether, aldehyde, ketone, alcohol, and hydrocarbon types, can be used as perfume oils or fragrances. Aroma compounds of the ester type are, for example, benzyl acetate, phenoxyethyl isobutyrate, p-tert.-butylcyclohexyl acetate, linalyl acetate, dimethylbenzylcarbinyl acetate, phenylethyl acetate, linalyl benzoate, benzyl formate, ethylmethylphenyl glycinate, allylcyclohexyl propionate, styrallyl propionate, and benzyl salicylate. The ethers include, for example, benzylethyl ether; the aldehydes, for example, the linear alkanals having 8-18 C atoms, citral, citronellal, citronellyloxyacetaldehyde, cyclamenaldehyde, hydroxycitronellal, lilial and bourgeonal; the ketones, for example, the ionones, α-isomethylionone and methylcedryl ketone; the alcohols, anethol, citronellol, eugenol, geraniol, linalool, phenylethyl alcohol and terpineol; and the hydrocarbons include principally the terpenes such as limonene and pinene. Preferably, however, mixtures of different aromas that together produce an attractive fragrance note are used. Such perfume oils can also contain natural aroma mixtures, such as those accessible from plant sources, for example pine, citrus, jasmine, patchouli, rose, or ylang-ylang oil. Also suitable are muscatel, salvia oil, chamomile oil, clove oil, lemon balm oil, mint oil, cinnamon leaf oil, linden blossom oil, juniper berry oil, vetiver oil, olibanum oil, galbanum oil, and labdanum oil, as well as orange blossom oil, neroli oil, orange peel oil, and sandalwood oil.

The fragrances can be processed directly, but it may also be advantageous to apply the fragrances onto carriers that ensure a slower fragrance release for longer-lasting fragrance. Cyclodextrins, for example, have proven successful as carrier materials of this kind; the cyclodextrin-perfume complexes can additionally be coated with further adjuvants.

Dyes

Preferred dyes, the selection of which will present absolutely no difficulty to one skilled in the art, possess excellent shelf stability and insensitivity to the other ingredients of the agents and to light, and no pronounced substantivity with respect to the substrates to be treated with the dye-containing agents, such as glass, ceramics, or plastic dishes, in order not to color them.

In addition to the components already exhaustively described, the washing and cleaning agents according to the present invention can contain further ingredients that further improve the applications-engineering and/or aesthetic properties of those agents. In the context of the present invention, preferred agents contain one or more substances from the group of the electrolytes, pH adjusting agents, fluorescence agents, hydrotropes, foam inhibitors, silicone oils, anti-redeposition agents, optical brighteners, graying inhibitors, shrinkage preventers, wrinkle protection agents, color transfer inhibitors, antimicrobial ingredients, germicides, fungicides, antioxidants, antistatic agents, ironing adjuvants, repellents and impregnating agents, stabilizing and anti-slip agents, and UV absorbers.

A large number of very varied salts from the group of the inorganic salts can be used as electrolytes. Preferred cations are the alkali and alkaline-earth metals, preferred anions are the halides and sulfates. In terms of production engineering, the use of NaCl or MgCl₂ in the agents according to the present invention is preferred.

In order to bring the pH of the agents according to the present invention into the desired range, the use of pH adjusting agents may be indicated. All known acids and bases are usable here, provided their use is not prohibited for environmental or applications-engineering reasons, or for reasons of consumer safety. The quantity of these adjusting agents usually does not exceed 1 wt % of the entire formulation.

Appropriate foam inhibitors that can be used in the agents according to the present invention are, for example, soaps, paraffins, or silicone oils, which optionally can be applied onto carrier materials. Suitable anti-redeposition agents (also referred to as soil repellents) are, for example, nonionic cellulose ethers such as methyl cellulose and methylhydroxypropyl cellulose having a 15- to 30-wt % concentration of methoxy groups and a 1- to 15-wt % concentration of hydroxypropyl groups, based in each case on the nonionic cellulose ethers, as well as the polymers, known from the existing art, of phthalic acid and/or terephthalic acid or their derivatives, in particular polymers of ethylene terephthalates and/or polyethylene glycol terephthalates or anionically and/or nonionically modified derivatives thereof. Of these, the sulfonated derivatives of the phthalic acid and terephthalic acid polymers are particularly preferred.

Optical brighteners (so-called “whiteners”) can be added to the agents according to the present invention in order to eliminate graying and yellowing of the treated textiles. These substances are absorbed onto the fibers and cause a brightening and simulated bleaching effect by converting invisible ultraviolet radiation into visible longer-wave light; the ultraviolet light absorbed from sunlight is radiated as a weakly bluish fluorescence, combining with the yellow tint of the grayed or yellowed laundry to yield pure white. Suitable compounds derive, for example, from the substance classes of the 4,4′-diamino-2,2′-stilbenedisulfonic acids (flavonic acids), 4,4′-distyrl biphenylene, methylumbelliferones, cumarins, dihydroquinolinones, 1,3-diarylpyrazolines, naphthalic acid imides, benzoxazole, benzisoxazole, and benzimidazole systems, and the pyrene derivatives substituted with heterocycles.

The purpose of graying inhibitors is to keep dirt released from the fibers suspended in the bath, thus preventing the dirt from redepositing. Water-soluble colloids, usually organic in nature, are suitable for this, for example the water-soluble salts of polymeric carboxylic acids, size, gelatins, salts of ethersulfonic acids of starch or cellulose, or salts of acid sulfuric acid esters of cellulose or starch. Water-soluble polyamides containing acid groups are also suitable for this purpose. Soluble starch preparations, and starch products other than those mentioned above, can also be used, e.g. degraded starch, aldehyde starches, etc. Polyvinylpyrrolidone is also usable. Also usable as graying inhibitors are cellulose ethers such as carboxymethyl cellulose (Na salt), methyl cellulose, hydroxyalkyl cellulose, and mixed ethers such as methylhydroxyethyl cellulose, methylhydroxypropyl cellulose, methylcarboxylmethyl cellulose, and mixtures thereof.

Because textile fabrics, in particular those made of rayon, viscose, cotton, and mixtures thereof, can tend to wrinkle because the individual fibers are sensitive to bending, kinking, compression, and squeezing transversely to the fiber direction, the agents according to the present invention can contain synthetic wrinkle-prevention agents. These include, for example, synthetic products based on fatty acids, fatty acid esters, fatty acid amides, fatty acid alkylol esters, fatty acid alkylolamides, or fatty alcohols that are usually reacted with ethylene oxide, or products based on lecithin or modified phosphoric acid esters.

To counteract microorganisms, antimicrobial active substances can be used. A distinction is made here, in terms of the antimicrobial spectrum and mechanism of action, between bacteriostatics and bactericides, fungistatics and fungicides, etc. Important substances from these groups are, for example, benzalkonium chlorides, alkylarylsulfonates, halogen phenols, and phenol mercuric acetate; these compounds can also be entirely dispensed with in the agents according to the present invention.

To prevent undesirable changes to the washing and cleaning agents and/or to the treated textiles caused by the action of oxygen and other oxidative processes, the agents can contain antioxidants. This class of compounds includes, for example, substituted phenols, hydroquinones, catechols, and aromatic amines, as well as organic sulfides, polysulfides, dithiocarbamates, phosphites, and phosphonates.

Increased wearing comfort can result from the additional use of antistatic agents, which are additionally incorporated into the agents according to the present invention. Antistatic agents increase the surface conductivity and thus make possible improved dissipation of charges that have formed. External antistatic agents are usually substances having at least one hydrophilic molecule ligand, and form a more or less hygroscopic film on the surfaces. These usually surface-active antistatic agents can be subdivided into nitrogen-containing (amines, amides, quaternary ammonium compounds), phosphorus-containing (phosphoric acid esters), and sulfur-containing antistatic agents (alkylsulfonates, alkyl sulfates). Lauryl (or stearyl) dimethylbenzylammonium chlorides are likewise suitable as antistatic agents for textiles or as an additive to washing agents, a reviving effect additionally being achieved.

For textile care and in order to improve textile properties, such as a softer “hand” (reviving) and decreased electrostatic charge (increased wearing comfort), the agents according to the present invention can contain conditioners. The active substances in conditioner formulations are “esterquats,” quaternary ammonium compounds having two hydrophobic radicals, such as, for example, distearyidimethylammonium chloride, although because of its insufficient biodegradability the latter is increasingly being replaced by quaternary ammonium compounds that contain, in their hydrophobic radicals, ester groups as defined break points for biodegradation.

In order to improve the water absorption capability and rewettability of the treated textiles and to facilitate ironing of the treated textiles, silicone derivatives, for example, can be used in the agents according to the present invention. These additionally improve the rinsing behavior of the agents according to the present invention as a result of their foam-inhibiting properties. Preferred silicone derivatives are, for example, polydialkyl or alkylaryl siloxanes in which the alkyl groups have one to five C atoms and are entirely or partly fluorinated. Preferred silicones are polydimethyl siloxanes, which optionally can be derivatized and are then aminofunctional or quaternized or have Si—OH, Si—H, and/or Si—Cl bonds.

Lastly, the agents according to the present invention can also contain UV absorbers that are absorbed onto the treated textiles and improve the light-fastness of the fibers. Compounds that exhibit these desired properties are, for example, the compounds that act by radiationless deactivation, and derivatives of benzophenone having substituents in the 2- and/or 4-position. Also suitable are substituted benzotriazoles, acrylates phenyl-substituted in the 3-position (cinnamic acid derivatives) optionally having cyano groups in the 2-position, salicylates, organic Ni complexes, and natural substances such as umbelliferone and endogenous urocanic acid.

1-18. (canceled)

19. A product comprising: (a) a shaped element comprising a first agent selected from washing and cleaning actives and mixtures thereof; and (b) at least one water-soluble or water-dispersible film material; wherein the film material is adherently joined to the shaped element by a heat-sealed seam.

20. The product according to claim 19, wherein the shaped element has a cavity, and wherein the cavity is at least partially sealed by the film material adherently joined to the shaped element.

21. The product according to claim 20, wherein the cavity is at least partially filled with a second agent selected from washing and cleaning actives and mixtures thereof.

22. The product according to claim 19, wherein the film material is shaped into a hollow element selected from the group consisting of injection-molded parts, blow-molded parts, deep-drawn parts, and combinations thereof.

23. The product according to claim 20, wherein the film material is shaped into a hollow element selected from the group consisting of injection-molded parts, blow-molded parts, deep-drawn parts, and combinations thereof.

24. The product according to claim 23, wherein at least a portion of the hollow element is disposed within the cavity.

25. The product according to claim 19, wherein the shaped element comprises a single- or multi-phase tablet.

26. The product according to claim 22, wherein the hollow element contains a liquid filling.

27. The product according to claim 19, wherein at least a portion of the shaped element which is adherently joined to the film material has a surfactant content below 20% by weight.

28. The product according to claim 19, wherein at least a portion of the shaped element which is adherently joined to the film material has an enzyme content below 6% by weight.

29. The product according to claim 19, wherein at least a portion of the shaped element which is adherently joined to the film material has bleaching agent content below 15% by weight.

30. The product according to claim 19, wherein at least a portion of the shaped element which is adherently joined to the film material has bleach activator content below 5% by weight.

31. The product according to claim 19, wherein at least a portion of the shaped element which is adherently joined to the film material has a builder content above 10% by weight.

32. The product according to claim 19, wherein at least a portion of the shaped element which is adherently joined to the film material has a polymer content above 0.5% by weight.

33. The product according to claim 19, wherein the seam comprises a continuous peripheral seam.

34. The product according to claim 19, wherein the seam comprises two or more separate seams.

35. The product according to claim 19, wherein the shaped element has a breaking pressure above 1 bar.

36. The product according to claim 19, wherein the shaped element has a coating on at least a portion of a surface of the shaped element

37. A method for manufacturing a washing or cleaning product, said method comprising:
(a) providing a shaped element comprising a first agent selected from washing and cleaning actives and mixtures thereof;
(b) providing a water-soluble or water-dispersible film material; and
(c) forming a heat-sealed-seam between the film material and the shaped element.

38. The method according to claim 37, wherein the shaped element has a coating on at least a portion of a surface of the shaped element.
